(19) United States
(12) Patent Application Publication
(10) Pub. No.: US 2015/0191645 A1
(43) Pub. Date: Jul. 9, 2015

(54) ANTI-AGGLOMERANTS FOR THE PREVENTION OF HYDRATES

(71) Applicant: Weatherford/Lamb, Inc., Houston, TX (US)

(72) Inventors: Simon John Michael LEVEY, Edmonton (CA); Robert FOWLES, Edmonton (CA); Duane S. TREYBIG, Elkhart, TX (US)

(21) Appl. No.: 14/546,599

(22) Filed: Nov. 18, 2014

Related U.S. Application Data
(60) Provisional application No. 61/906,621, filed on Nov. 20, 2013.

(51) Int. Cl. C09K 8/52

(52) U.S. Cl. CPC C09K 8/52; C09K 2208/22; C09K 2208/32

(57) ABSTRACT

The implementations described herein relate to imidazoline quaternary ammonium based compositions, processes for the preparation thereof and to the use of imidazoline quaternary ammonium based compositions as anti-agglomerants. In some implementations, the anti-agglomerant compositions described herein are able to handle greater than 10° C. subcooling in a sour system up to 40,000 ppm H₂S and also without the need for a hydrocarbon phase. It is believed that some of the anti-agglomerants described herein can function without a hydrocarbon phase in sour conditions.

### CROSS-REFERENCE TO RELATED APPLICATIONS

This application claims benefit of U.S. provisional patent application Ser. No. 61/906,621, filed Nov. 20, 2013, which is herein incorporated by reference in its entirety.

### BACKGROUND

1. Field

Implementations described herein generally relate to reducing or inhibiting the formation and growth of hydrate particles in fluids containing hydrocarbons and water. Implementations described herein further pertain to reducing or inhibiting the formation and growth of hydrate particles in the production and transport of natural gas, petroleum gas, or other gases.

2. Description

Gas hydrates can be easily formed during the transportation of oil and gas in pipelines when the appropriate conditions are present. Water content, low temperatures and elevated pressure are required for the formation of gas hydrates. The formation of gas hydrates often results in lost oil production, pipeline damage, and safety hazards to field workers. Modern oil and gas technologies commonly operate under severe conditions during the course of oil recovery and production; for instance, high pumping speed, high pressure in the pipelines, extended length of pipelines, and low temperature of the oil and gas flowing through the pipelines. These conditions are particularly favorable for the formation of gas hydrates, which can be particularly hazardous for oil production offshore or for locations with cold climates.

Gas hydrates are ice-like crystals formed from water, small non-polar molecules such as natural gases (e.g., methane, propane, hydrogen sulfide and carbon dioxide) and other liquids at lower temperatures and increased pressures. Hydrate crystals can form when hydrocarbons and water are present at the right temperature and pressure, such as in wells, flow lines or valves. The gases dissolve into the water and begin to nucleate eventually forming a cage-like hydrate crystal. The hydrates go from a slushy state, to a sticky stage (where particulates readily adhere to each other) and then to a non-aggregating particulate stage. The hydrocarbons become entrapped in the cage-like hydrate crystals which do not flow, but which rapidly grow and agglomerate to sizes which can block flow lines. The specific structure of the cage-like crystals can be of several types (e.g., type I, type II, type H), depending upon the identity of the gases.

Once formed, these crystalline cage structures tend to settle out from the solution and accumulate into large solid masses that can travel by oil and gas transporting pipelines, and potentially block or damage the pipelines and/or related equipment. The damage resulting from a blockage can be very costly from an equipment repair standpoint, as well as from the loss of production, and finally the resultant environmental impact. Thus hydrate formation-treatment-prevention is a multi-billion dollar endeavor. High costs are expected from production loss and with actual removal of hydrate blockage. As pipelines are constructed in more challenging conditions and extending the life of old pipelines becomes more paramount, new hydrate inhibitor technology will be required.

The choice and success of a chemical hydrate inhibitor may be affected by several factors including: types of gases (hydrate structure), salinity, water cut and water composition, pressure, temperature, the presence of corrosion inhibitors and other chemicals, sub-cooling and shut in times among other factors. The industry uses a number of methods to prevent such blockages such as thermodynamic inhibitors, kinetic hydrate inhibitors and anti-agglomerants. Thermodynamic inhibitors may be used to adjust equilibrium conditions and prevent hydrate formation. However, large volumes of thermodynamic inhibitors are required for prevention of hydrate formation which may result in environmental concerns. Low doses of kinetic hydrate inhibitors slow the growth rate of hydrate crystals but are significantly affected by factors such as sub-cooling, water cuts and shut in times. Low doses of anti-agglomerants may be used to prevent hydrate forming particles from agglomerating. Anti-agglomerants are typically not affected by sub-cooling and many of these products are environmentally friendly and work best where shut-ins occur. However, anti-agglomerants typically require a hydrocarbon layer or phase for them to act; that is they are not expected to work where 100% water cut exists.

Therefore there is a need for hydrate inhibitors that can effectively function in a sour environment at high water cut and in the presence of corrosion inhibitors as there are a number of wells that are sour.

### SUMMARY

Accordingly, implementations described herein pertain to anti-agglomerant compositions and methods for inhibiting the formation of hydrate agglomerants in an aqueous medium comprising water, gas, and optionally liquid hydrocarbons. In one implementation, a composition comprising the quaternaries of the reaction products of at least one of (a) ethylenediamine and tall oil fatty acid, (b) N-(2-aminoethyl)piperazine and tall oil fatty acid, (c) triethylenetetramine and tall oil fatty acid, (d) tetraethylenepentamine and tall oil fatty acid, (e) E-100 and tall oil fatty acid, (f) N-(2-aminoethyl)ethanolamine, N-(2-aminoethyl)piperazine and triethylentetramine with tall oil fatty acid, (g) N-(2-aminoethyl)ethanolamine, N-(2-aminoethyl)piperazine, triethylentetramine, 5-ethyl-1,4,7-triazabicyclo(4.3.0)-non-6-ene and 5-ethyl-1,4,7-triazabicyclo(4.3.0) non-4,6-diene with tall oil fatty acid, (f) and combinations thereof is provided. The quaternization agent may be selected from the group consisting of: dimethyl sulfate, diethyl sulfate, benzyl chloride, methyl chloride, dichloroethylether and combinations thereof.

In another implementation, a composition comprising the quaternaries of tall oil fatty acid and at least one of the following ethyleneamines as defined by Formulas (I)-(IV):

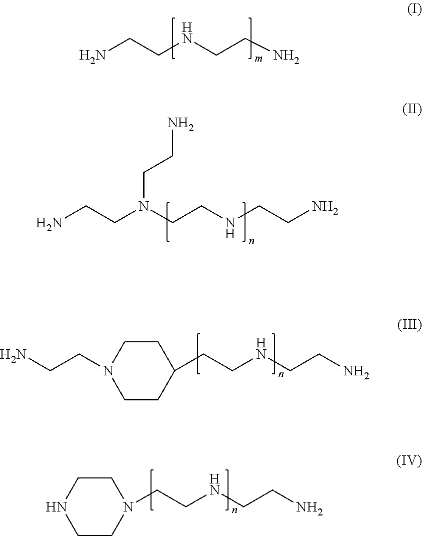

wherein n is 0 or from 1 to 9 and m is 0 or from 2 to 9 is provided. The quaternization agent may be selected from the group consisting of: dimethyl sulfate, diethyl sulfate, benzyl chloride, methyl chloride, dichloroethylether and combinations thereof.

In another implementation, a composition comprising the quaternaries of the reaction products of at least one of: (a) N-(2-hydroxyethyl)piperazine and tall oil fatty acid, (b) N-hydroxyethyldiethylenetriamine and tall oil fatty acid. (c) 1,7-bishydroxyethyldiethylenetriamine and tall oil fatty acid, (d) N-hydroxyethyl triethylenetetramine and tall oil fatty acid, (e) N,N′-bishydroxyethyl triethylenetetramine and tall oil fatty acid, (f) N-hydroxyethyl tetraethylenepentamine and tall oil fatty acid, (g) N,N′-bishydroxyethyl tetraethylenepentamine and tall oil fatty acid, (h) N-hydroxyethyl E-100 and tall oil fatty acid, (i) N,N′-bishydroxyethyl E-100 and tall oil fatty acid, (j) N-(2-aminoethyl)ethanolamine and 1-[(2-aminoethyl)amino]-1-hydroxy-ethyl with tall oil fatty acid, (k) N-hydroxyethyldiethylenetriamine and 1-[[2-aminoethyl)amino]ethyl]amino]-ethanol with tall oil fatty acid, (l) N-hydroxyethyltriethylenetetramine and 1-[[2-[[2-aminoethyl)amino]ethyl]amino]ethyl]amino]ethanol with tall oil fatty acid and (m) combinations thereof is provided. The quaternization agent may be selected from the group consisting of: dimethyl sulfate, diethyl sulfate, benzyl chloride, methyl chloride, dichloroethylether and combinations thereof.

In another implementation, a composition comprising the quaternaries of tall oil fatty acid and at least one of the following ethoxylated ethyleneamine structures as defined by Formulas (I)-(IX):

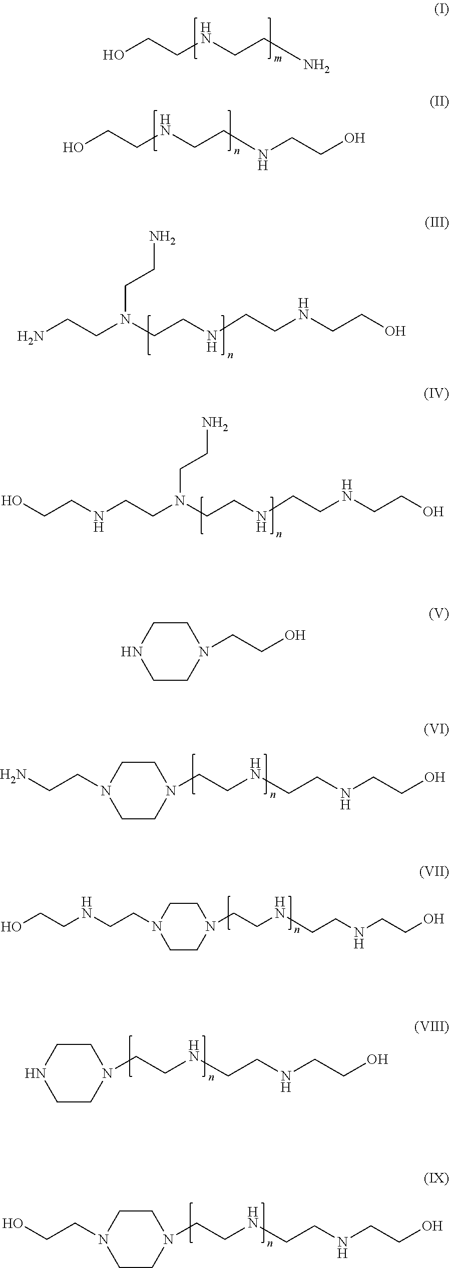

wherein n is 0 or from 1 to 8 and m is from 2 to 9 is provided. The quaternization agent may be selected from the group consisting of: dimethyl sulfate, diethyl sulfate, benzyl chloride, methyl chloride, dichloroethylether and combinations thereof.

In yet another implementation, a composition comprising the quaternaries of at least one of: C₁₇-hydroxyethylimidazolines and amides, C₁₇-aminoethylimidazolines and amides, C₁₈-aminoethylpiperazine amides and combinations thereof is provided. The quaternization agent may be selected from the group consisting of: dimethyl sulfate, diethyl sulfate, benzyl chloride, methyl chloride, dichloroethylether and combinations thereof.

In yet another implementation, a composition comprising the quaternaries of at least one of: C₁₇-hydroxyethylimidazolines and amides, C17-aminoethylimidazolines and amides, C₁₈-aminoethylpiperazine amides, 5-ethyl-1,4,7-triazabicyclo(4.3.0) non-6-ene and 5-ethyl-1,4,7-triazabicyclo(4.3.0)non-4,6-diene is provided. The quaternization agent may be selected from the group consisting of: dimethyl sulfate, diethyl sulfate, benzyl chloride, methyl chloride, dichloroethylether and combinations thereof.

In yet another implementation, a composition comprising the quaternaries of C₁₇-aminoethylimidazoline and C₁₇-triethylenetetramine imides and amides as hydrate inhibitor performance enhancers (or activators) when added to diethyl sulfate quaternaries of C₁₇ hydroxyethylimidazolines and amides is provided. The quaternization agent may be selected from the group consisting of: dimethyl sulfate, diethyl sulfate, benzyl chloride, methyl chloride, dichloroethylether and combinations thereof.

In yet another implementation, an anti-agglomerant composition comprising the quaternaries of the reaction product of tall oil fatty acid and N-(2-aminoethyl)ethanolamine (AEEA) is provided. In some implementations, the quaternization agent is selected from the group consisting of: dimethyl sulfate, diethyl sulfate, benzyl chloride, methyl chloride, dichloroethylether and combinations thereof. In some implementations, the anti-agglomerant composition further comprises 1-[(2-aminoethyl)amino]-1-hydroxy-ethyl. In some implementations, the anti-agglomerant composition further comprises an effective hydrate performance inhibitor enhancing amount of at least one of (a) diethyl sulfate quaternaries of the reaction product of tall oil fatty acid and triethylenetetramine and (b) diethyl sulfate quaternaries of the reaction product of tall oil fatty acid and diethylenetriamine.

In yet another implementation, a composition comprising the diethyl sulfate quaternaries of the reaction product of tall oil fatty acid and a mixture of aminoethyl ethanolamine, N-(2-aminoethyl)piperazine and triethylenetetramine is provided.

In yet another implementation, a composition prepared by reacting a C₁₆-C₂₃ fatty acid with (a) one or more ethyleneamines, excluding diethylenetriamine and (N-(2-aminoethyl)ethanolamine, to form one or more di-alkyl substituted imidazolines, one or more di-alkyl substituted amides, one or more monoalkyl substituted amides, or mixtures thereof, (b) reacting the resulting one or more di-alkyl substituted imidazolines, one or more di-alkyl substituted amides, one or more monoalkyl substituted amides, or mixtures thereof with a quaternization agent is provided. In some implementations, the C₁₆-C₂₃ fatty acid is selected from the group consisting of: tall oil fatty acid, coco fatty acid and erucic acid. In some implementations, the quaternization agent is selected from the group consisting of: dimethyl sulfate, diethyl sulfate, benzyl chloride, methyl chloride, dichloroethylether and combinations thereof. In some implementations, the one or more ethyleneamines comprise at least one of the aforementioned ethyleneamines. In some implementations, the composition comprises at least one of C₁₇-hydroxyethylimidazolines, C₁₇-hydroxyethylamides, C₁₇-aminoethylimidazolines, C₁₇-aminoethylamides, C₁₈-aminoethylpiperazine amide and combinations thereof. In some implementations, the composition comprises at least one of: C17-hydroxyethylimidazolines and amides, C17-aminoethylimidazolines and amides, C18-aminoethylpiperazine amides, 5-ethyl-1,4,7-triazabicyclo(4.3.0) non-6-ene, 5-ethyl-1,4,7-triazabicyclo(4.3.0)non-4,6-diene and combinations thereof.

In yet another implementation, a gas hydrate inhibitor composition is provided. The composition comprises the following Formula (I) and optionally salts thereof:

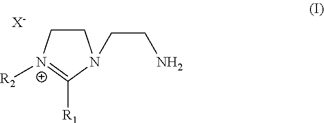

wherein R₁ is a C₈-C₂₃ alkyl or alkenyl, wherein R₂ is a C₁ to C₂ alkyl and X⁻ is a counterion. In some implementations, each alkyl is independently selected from the group consisting of a straight chain alkyl, a branched chain alkyl, a saturate version of the foregoing and an unsaturated version of the foregoing and combinations thereof. In some implementations, the alkyl for R₂ is ethyl or methyl. In some implementations, the alkyl for R₁ is a C₁₅-C₁₈ alkyl. In some implementations, the alkyl for R₁ is a C₁₇ alkyl and the alkyl for R₂ is ethyl. In some implementations, R₁ is derived from tall oil fatty acid, oleic acid, coco fatty acid or erucic acid.

In yet another implementation, a gas hydrate inhibitor composition is provided. The composition comprises the following Formula (I) and optionally salts thereof:

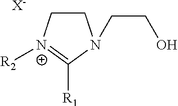

wherein R₃ is a C₈-C₂₃ alkyl or alkenyl, wherein R₄ is a C₁ to C₂ alkyl, and X⁻ is a counterion. In some implementations, the alkyl for R₂ is ethyl or methyl. In some implementations, the alkyl for R₁ is a C₁₅-C₂₀ alkyl. In some implementations, the alkyl for R₁ is a C₁₇ alkyl and the alkyl for R₂ is ethyl.

In yet another implementation, a composition is provided. The composition comprises the following Formula (I) and optionally salts thereof:

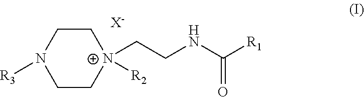

wherein R₁ is a C₈-C₂₃ alkyl or alkenyl, wherein R₂ is a C₁ to C₂ alkyl, wherein R₃ is H or a C₁-C₂ alkyl and X⁻ is a counterion. In some implementations, each alkyl is independently selected from the group consisting of a straight chain alkyl, a branched chain alkyl, a saturate version of the foregoing and an unsaturated version of the foregoing and combinations thereof. In some implementations, the alkyl for R₂ is ethyl or methyl. In some implementations, the alkyl for R₁ is a C₁₅-C₁₈ alkyl. In some implementations, the alkyl for R₁ is a C₁₇ alkyl and the alkyl for R₂ is ethyl. In some implementations, R₁ is derived from tall oil fatty acid, oleic acid, coco fatty acid or erucic acid.

In yet another implementation, an anti-agglomerate composition is provided. The composition comprises a diethyl sulfate quaternary of a polymer containing a vinyl caprolactam, vinyl pyrolidone, dimethylaminoethylmethacrylate terpolymer or a polymer containing vinyl caprolactam and dimethylaminoethylmethacrylate copolymer.

In yet another implementation, an anti-agglomerate composition is provided. The composition comprises a diethyl sulfate quaternary of a polymer containing a vinyl caprolactam, vinyl pyrolidone, dimethylaminoethylmethacrylate terpolymer.

In yet another implementation, an anti-agglomerate composition is provided. The anti-agglomerate composition comprises the following Formula (I) and optionally salts thereof:

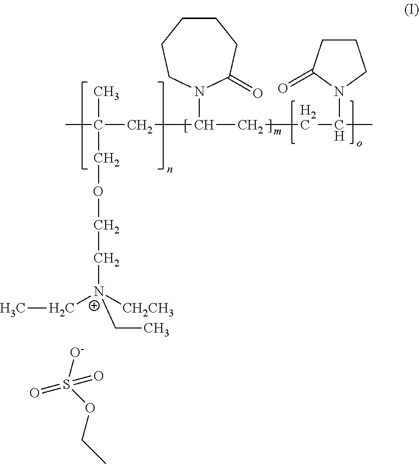

wherein n=1, m=10 to 40 (e.g., 15 to 35; 20 to 30) and o=5 to 20 (e.g., 9 to 10; 10 to 15).

In yet another implementation, an anti-agglomerate composition is provided. The anti-agglomerate composition comprises the following Formula (I) and optionally salts thereof:

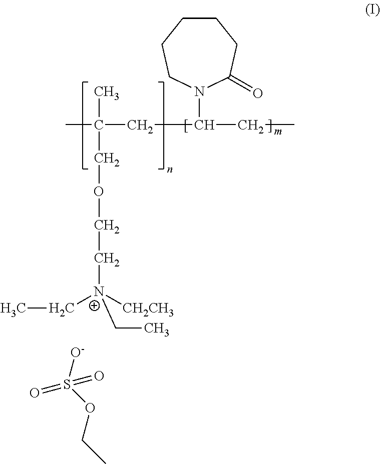

wherein n=1 and m=5 to 100 (e.g., 10 to 20; 20 to 80; 30 to 40).

In yet another implementation, an anti-agglomerate composition is provided. The anti-agglomerate composition comprises diethyl sulfate quaternary of at least one of: tetrahydroxyethyldiethylenetriamine, trihydroxyethyldiethylenetriamine, pentahydroxyethyldiethylenetriamine, tetrahydroxyethyltriethylenetetramine, pentahydroxyethyltriethylenetetramine, hexahydroxyethyltriethylenetetramine, tetrahydroxyethyltetraethylenepentamine, pentahydroxyethyltetraethylenepentamine, hexahydroxyethyltetraethylenepentamine, heptahydroxyethyltetraethylenepentamine, tetrahydroxyethyl E-100, pentahydroxyethyl E-100, hexahydroxyethyl E-100, heptahydroxyethyl E-100 and octahydroxyethyl E-100.

In yet another implementation, an anti-agglomerate composition is provided. The anti-agglomerate composition comprises diethyl sulfate quaternary of tetrahydroxyethyldiethylenetriamine.

In yet another implementation, an anti-agglomerate composition is provided. The anti-agglomerate composition comprises the following Formula (I) and optionally salts thereof:

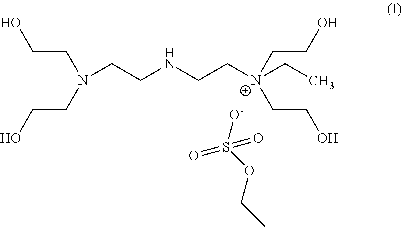

In some implementations, any of the aforementioned compositions further comprise at least one component selected from: one or more kinetic hydrate inhibitors, one or more thermodynamic hydrate inhibitors, one or more additional anti-agglomerants, and combinations thereof.

In some implementations, any of the aforementioned compositions further comprise at least one component selected from: asphaltene inhibitors, paraffin inhibitors, corrosion inhibitors, scale inhibitors, emulsifiers, water clarifiers, dispersants, emulsion breakers, and combinations thereof.

In some implementations, any of the aforementioned compositions further comprise at least one polar or nonpolar solvent or a mixture thereof. In some implementations the at least one solvent is selected from the group consisting of: isopropanol, methanol, ethanol, 2-ethylhexanol, heavy aromatic naphtha, toluene, ethylene glycol, ethylene glycol monobutyl ether (EGMBE), diethylene glycol monoethyl ether, xylene, and combinations thereof.

In some of the aforementioned implementations, X⁻ is R₃SO₄⁻ and R₃ is ethyl.

In yet another implementation, a method of inhibiting the formation of hydrate agglomerates in a fluid comprising water, gas, and optionally liquid hydrocarbon comprising adding to the fluid an effective anti-agglomerant amount of any of the aforementioned compositions is provided. In some implementations the gas comprises hydrogen sulfide. In some implementations, the fluid has a water cut from 0.1% to 100% v/v. In some implementations, the fluid is contained in an oil or gas pipeline or refinery. In some implementations, the fluid has a salinity of 1% to 35% w/w percent TDS. In some implementations, wherein adding to the fluid an effective anti-agglomerant amount of any of the aforementioned compositions further comprises adding an effective corrosion inhibition amount of any of the aforementioned compositions. In some implementations, the fluid has a water cut of up to 100% v/v.

### BRIEF DESCRIPTION OF THE DRAWINGS

The patent or application file contains at least one drawing executed in color. Copies of this patent or patent application publication with color drawings(s) will be provided by the Office upon request and payment of the necessary fee.

So that the manner in which the above recited features of the present invention can be understood in detail, a more particular description of the invention, briefly summarized above, may be had by reference to implementations, some of which are illustrated in the appended drawings. It is to be noted, however, that the appended drawings illustrate only typical implementations of this invention and are therefore not to be considered limiting of its scope, for the invention may admit to other equally effective implementations.

FIG. 1 depicts a plot illustrating the temperature profile for KHI1 and KHI2 inhibitor;

FIG. 2 depicts a plot illustrating the torque values for KHI1 and KHI2 inhibitor;

FIG. 3 depicts a plot illustrating the torque values obtained for the composition of Example 2;

FIG. 4 depicts a plot illustrating exotherms for KHI1 and the composition of Example 2;

FIGS. 5A-5B depict plots illustrating the torque values for various kinetic hydrate inhibitors and anti-agglomerants in a 0.4% H₂S and 99.6% methane environment;

FIG. 6 depicts a plot illustrating the torque values for selected inhibitors in a 24 hour shut-down system;

FIG. 7 depicts a plot illustrating the pressure drop compared to temperature change for the control and the composition of Example 2;

FIG. 8 depicts a plot illustrating the torque values obtained for various anti-agglomerants in 1% H₂S and corrosion inhibitor;

FIG. 9 depicts a plot illustrating the torque values obtained for various anti-agglomerants in 2% H₂S;

FIG. 10 depicts a plot illustrating the torque values obtained for various anti-agglomerants in 4% H₂S;

FIG. 11 depicts a plot illustrating the results of hydrate prediction software;

FIG. 12 depicts a plot illustrating the torque values obtained for various anti-agglomerants in 25% water cut and 1% H₂S mixed gases;

FIG. 13 depicts a plot illustrating the torque values obtained for the composition of Example 7 in condensate brine (75:25) and 1% H₂S;

FIG. 14 depicts a plot illustrating the effect of the composition of Example 7 on corrosion rate in comparison with a commercially available corrosion inhibitor;

FIG. 15 depicts a plot illustrating the torque values (at 150 rpm) obtained for Example 7 and KHI5 in 200 mL DRILLSOL® PLUS: brine (75:25) and sweet mixed gases;

FIG. 16 depicts a plot illustrating the torque values (at 150 rpm) obtained for Example 7 and KHI5 in 25% water cut and 1% H₂S mixed gases;

FIG. 17 shows the torque values (at 800 rpm) obtained for Example 7 in 25% water cut and 1% H₂S mixed gases;

FIG. 18 depicts a plot illustrating the torque values obtained for Example 7 in 100% water cut and sweet mixed gases at 1100 psi;

FIG. 19 depicts a plot illustrating the torque values obtained for the composition of Example 7 in 100% water cut and 1% H₂S;

FIG. 20 depicts a plot illustrating the torque obtained from analyzing memory effect; and

FIG. 21 depicts a plot illustrating the torque values obtained for various anti-agglomerants in 100% water cut and 4% H₂S.

### DETAILED DESCRIPTION

A gas hydrate is a solid mixture of gas and water that can form due to pressure and temperature changes in a system. If the formation of hydrates is not controlled these hydrates can lead to catastrophic consequences. Currently there is a need for hydrate inhibitors that can effectively function in a sour environment in the presence of corrosion inhibitors as there are a number of wells that are sour. Certain compositions and methods described herein can control hydrates as well as functioning effectively in the presence of corrosion inhibitors.

In some implementations, the anti-agglomerant compositions described herein are based on imidazoline quaternary ammonium chemistry and are able to handle greater than 10° C. subcooling in a sour system and at least 40,000 ppm H₂S and also without the need for a hydrocarbon phase. It is believed that the anti-agglomerants described herein which can function without a hydrocarbon phase in sour conditions are extremely unique. Testing has been conducted on both Type I and Type II sour hydrates with and without a hydrocarbon phase. The results show lower torque values for sour systems in the presence of a corrosion inhibitor indicating that performance is not affected. Further, corrosion testing shows that some of the anti-agglomerants described herein also help prevent pitting in sour conditions indicating that there may be a synergistic affect between the anti-agglomerant and corrosion inhibitor chemistry.

Many of the details, components of the other features described herein are merely illustrative of particular implementations. Accordingly, other implementations can have other details, components, and features without departing from the spirit or scope of the present disclosure. In addition, further implementations of the disclosure can be practiced without several of the details described below.

As used herein, the following terms have the meaning set forth below unless otherwise stated of clear from the context of their use.

When introducing elements of the present disclosure or exemplary aspects or implementation(s) thereof, the articles “a,” “an,” “the,” and “said” are intended to mean that there are one or more elements.

The terms “comprising,” “including,” and “having” are intended to be inclusive and mean that there may be additional elements other than the listed elements.

As used herein, the symbol “H” denotes a single hydrogen atom and may be used interchangeably with the symbol “—H”. “H” may be attached, for example, to an oxygen atom to form a “hydroxy” radical (i.e., —OH), or two “H” atoms may be attached to a carbon atom to form a “methylene” (—CH₂—) radical.

The terms “hydroxyl” and “hydroxy” may be used interchangeably.

The number of carbon atoms in a substituent can be indicated by the prefix “C_{A-B}” where A is the minimum and B is the maximum number of carbon atoms in the substituent.

The term “Alkenyl” refers to a monovalent group derived from a straight, branched, or cyclic hydrocarbon containing at least one carbon-carbon double bond by the removal of a single hydrogen atom from each of two adjacent carbon atoms of an alkyl group. Exemplary alkenyl groups include, for example, ethenyl, propenyl, butenyl, 1-methyl-2-buten-1-yl, and the like.

The term “Alkyl” refers to a monovalent group derived by the removal of a single hydrogen atom from a straight or branched chain or cyclic saturated or unsaturated hydrocarbon. Exemplary alkyl groups include methyl, ethyl, propyl, butyl, pentyl, hexyl, heptyl, octyl, nonyl, and decyl.

“X⁻” refers to a counterion to the positive charges on the quaternary nitrogen groups. The counterion may be a fragment of the quaternization agent. The counterion may be a halide selected from fluoride, chloride, bromide, iodide, or a sulfate of the general formula RSO₄⁻ where R is a C₁-C₂ alkyl.

### LIST OF ABBREVIATIONS

| | |
|---|---|
| COCO | Cocoamine fatty acid |
| Et | Ethyl |

In some implementations, the compositions described herein comprise a generic formula and optionally salts thereof as defined by Formula (I).

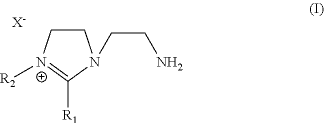

In formula (I), R₁ is a C₈-C₂₃ alkyl or alkenyl, wherein R₂ is CₙH₂ₙ₊₁ or benzyl. n is an integer from 1 to 10. X⁻ is a counterion. In some implementations of formula (I), each alkyl is independently selected from the group consisting of a straight chain alkyl, a branched chain alkyl, a saturate version of the foregoing and an unsaturated version of the foregoing and combinations thereof. In some implementations of formula (I), R₂ is ethyl or methyl. In some implementations of formula (I) R₁ is a C₁₅-C₁₈ alkenyl. In some implementations of formula (I), the alkenyl for R₁ is a C₁₇ alkenyl and the alkyl for R₂ is ethyl. In some implementations of formula (I), R₁ is derived from tall oil fatty acid, oleic acid, cocoamine fatty acid (“coco”) or erucic acid. In some implementations of formula (I), R₁ is at least one or a mixture of saturated or unsaturated C₈, C₁₀, C₁₂, C₁₄, C₁₆ and C₁₈. In some implementations, X⁻ is R₃SO₄⁻. In some implementations, R₃ is ethyl or methyl.

In some implementations the composition of Formula (I) is defined by the following formula and optionally salts thereof.

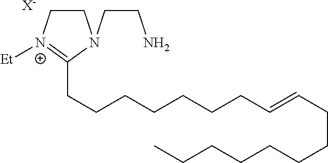

In some implementations the composition of Formula (I) is defined by the following formula and optionally salts thereof.

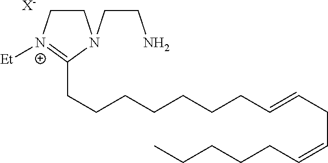

In some implementations, the compositions described herein comprise a generic formula and optionally salts thereof as defined by Formula (II).

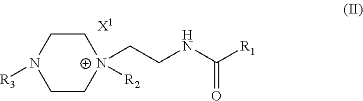

In Formula (II), R₁ is a C₈-C₂₃ alkyl or alkenyl, wherein R₂ is CₙH₂ₙ₊₁ alkyl or benzyl and R₃ is H or a CₙH₂ₙ₊₁ alkyl or benzyl. n is an integer from 1 to 10. X⁻ is a counterion. In some implementations of Formula (II), each alkyl is independently selected from the group consisting of a straight chain alkyl, a branched chain alkyl, a saturate version of the foregoing and an unsaturated version of the foregoing and combinations thereof. In some implementations of Formula (II), R₂ is ethyl or methyl. In some implementations of Formula (II), R₃ is ethyl or methyl. In some implementations of Formula (II) R₁ is a C₁₅-C₁₈ alkenyl. In some implementations of Formula (II), the alkenyl for R₁ is a C₁₇ alkenyl and the alkyl for R₂ and R₃ is ethyl. In some implementations of Formula (II), R₁ is derived from tall oil fatty acid, oleic acid, cocoamine fatty acid (“coco”) or erucic acid. In some implementations of Formula (II), R₁ is at least one or a mixture of saturated or unsaturated C₈, C₁₀, C₁₂, C₁₄, C₁₆ and C₁₈. In some implementations, X⁻ is R₄SO₄⁻. In some implementations, R₄ is ethyl or methyl.

In one implementation the composition of Formula (II) is defined by the following formula and optionally salts thereof.

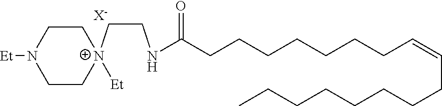

In one implementation the composition of Formula (II) is defined by the following formula and optionally salts thereof.

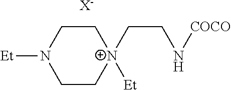

In some implementations, the compositions described herein comprise a mixture of the generic formula and optionally salts thereof as given in Formula (I) and the generic formula and optionally salts thereof as given in Formula (II).

In some implementations, the compositions described herein comprise a generic formula and optionally salts thereof as defined by Formula (III).

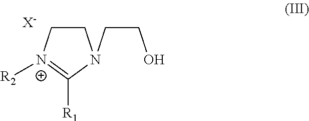

In Formula (III), R₁ is a C₈-C₂₃ alkyl or alkenyl, wherein R₂ is CₙH₂ₙ₊₁ or benzyl. n is an integer from 1 to 10. X⁻ is a counterion. In some implementations of Formula (III), each alkyl is independently selected from the group consisting of a straight chain alkyl, a branched chain alkyl, a saturate version of the foregoing and an unsaturated version of the foregoing and combinations thereof. In some implementations of Formula (III), R₂ is ethyl or methyl. In some implementations of Formula (III) R₁ is a C₁₅-C₁₈ alkenyl. In some implementations of Formula (III), the alkenyl for R₁ is a C₁₇ alkenyl and the alkyl for R₂ is ethyl. In some implementations of Formula (III), R₁ is derived from tall oil fatty acid, oleic acid, cocoamine fatty acid (“coco”) or erucic acid. In some implementations of Formula (III), R₁ is at least one or a mixture of saturated or unsaturated C₈, C₁₀, C₁₂, C₁₄, C₁₆ and C₁₈. In some implementations, X⁻ is R₃SO₄⁻. In some implementations, R₃ is ethyl or methyl.

In one implementation the composition of Formula (III) is defined by the following formula and optionally salts thereof.

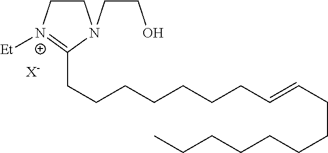

In one implementation the composition of Formula (III) is defined by the following formula and optionally salts thereof.

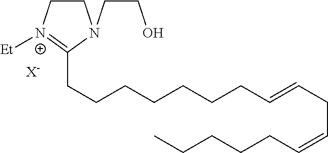

In one implementation the composition of Formula (III) is defined by the following formula and optionally salts thereof.

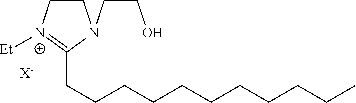

In one implementation the composition of Formula (III) is defined by the following formula and optionally salts thereof.

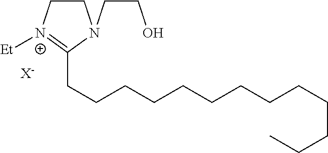

In some implementations, the compositions described herein comprise a generic formula and optionally salts thereof as defined by Formula (IV).

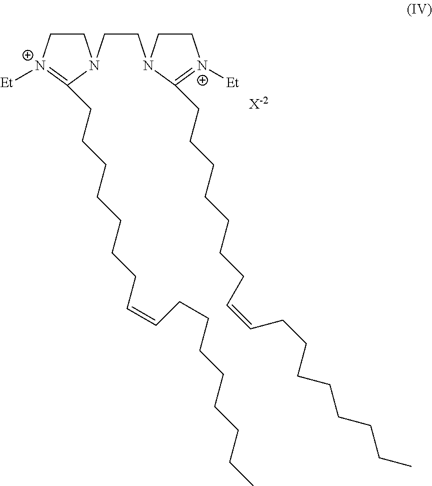

In some implementations, the compositions described herein comprise a mixture of at least two of the following: the generic formula and optionally salts thereof as given in formula (I), the generic formula and optionally salts thereof as given in formula (II), the generic formula and optionally salts thereof as given in formula (III) and the generic formula and optionally salts thereof as given in formula (IV).

The compositions described herein may be prepared by reacting at least one of a mono or dimer carboxylic acid with an ethyleneamine at conditions sufficient to cause the amino groups of the ethyleneamine to react with the acid group of the carboxylic acid. The resulting product is then reacted with a quaternization agent under sufficient conditions to form the quaternized composition. The quaternized composition may optionally be dissolved in a solvent.

Exemplary ethyleneamines that may be used include piperazines and hydroxyl alkyl substituted ethylenamines and ethoxylated ethyleneamines. Representative ethyleneamines include ethylenediamine (EDA), piperazine, N-(2-aminoethyl)ethanolamine (AEEA), 1-[(2-aminoethyl)amino]-1-hydroxy-ethyl, diethylenetriamine (DETA), crude aminoethylethanolamine, N-(2-hydroxyethyl)piperazine, N-hydroxyethyl diethylenetriamine (or 2-[[2-[(2-aminoethyl)amino]ethyl]amino]-ethanol), 1-[[2-minoethyl)amino]ethyl]amino]-ethanol, 1,7-bis(hydroxyethyl)diethylenetriamine (2,2′-[iminobis(2,1-ethanediylimino)]bisethanol), triethylentetramine (TETA), hydroxyethyl triethylenetetramine, 1-[[2-[[2-aminoethyl)amino]ethyl]amino]ethyl]amino]ethanol, N,N′-bishydroxyethyl triethylenetetramine, tetraethylenepentamine (TEPA), N-hydroxyethyl tetraethylenepentamine, N,N′-bishydroxyethyltetraethylenepentamine, pentaethylenehexamine, hexaethyleneheptamine, heptaethyleneoctamine, octaethylenenonamine, pentaethylenehexamine (PEHA), hexaethyleneheptamine (HEHA), aminoethylpiperazine (AEP), 5-methyl-1,4,7-triazabicyclo(4.3.0)-non-4,6-diene, 5-ethyl-1,4,7-triazabicylco(4.3.0)-non-6-ene; 5-ethyl-1,4,7-triazabicyclo(4.3.0)non-4,6-diene and combinations thereof.

Ethyleneamines include linear, branched and some contain piperazine rings. Exemplary ethyleneamines further include the following structures:

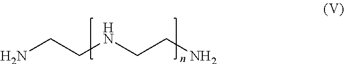

n is 0 or from 1 to 9.

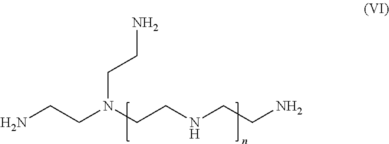

n is 0 or form 1 to 8.

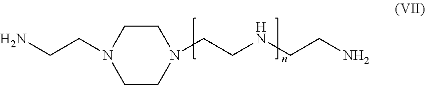

n is 0 or from 1 to 8.

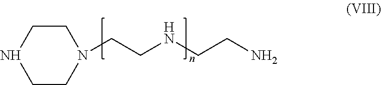

n is from 1 to 8.

Ethoxylated ethyleneamines include linear, branched and some contain piperazine rings. Exemplary ethoxylated ethyleneamines are defined by the following formulas:

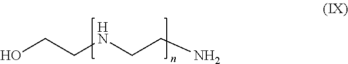

n is from 1 to 9.

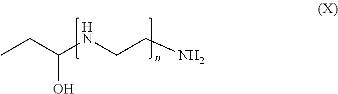

n is from 1 to 9.

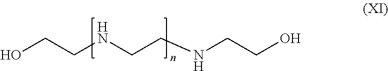

n is from 1 to 9.

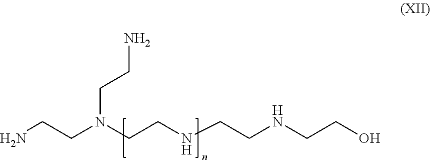

n is 0 or from 1 to 8.

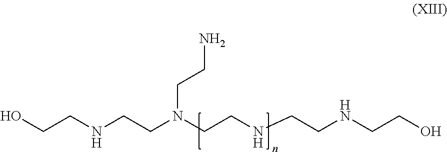

n is 0 or from 1 to 8.

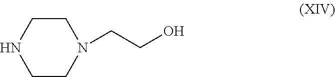

n is 0 or from 1 to 8.

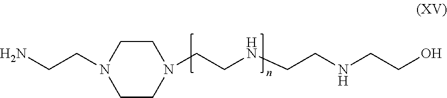

n is 0 or from 1 to 8.

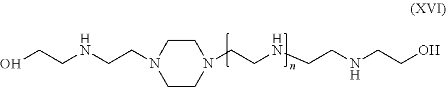

n is 0 or from 1 to 8.

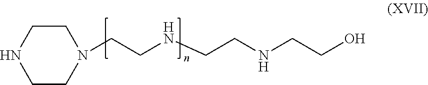

n is 0 or from 1 to 8.

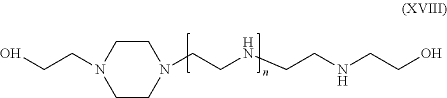

n is 0 or from 1 to 8.

In some implementations, N-Aminoethylethanolamine and N-aminoethylpiperazine are the preferred ethyleneamines. One example of a crude N-aminoethylethanolamine product is A-1328 which is mixture of aminoethyl ethanolamine, N-(2-aminoethyl)piperazine and triethylenetetramine. A-1328 is commercially available from Molex Company in Athens, Ala.

Exemplary mono and dimer carboxylic acids include tall oil fatty acid, oleic acid, coco fatty acid, and erucic acid. Tall oil fatty acid, oleic acid and coco fatty acid are the preferred carboxylic acids. Exemplary dimer acids include Emery 1003 dimer acid which is commercially available from Emery Oleochemicals.

In certain implementations, the source of fatty acids is a plant-based oil chosen from tall oils and tall oil products. In some implementations, the tall oil products are oxidized tall oil products. More generally, non-limiting examples of tall oil sources of fatty acids include various tall oil products such as without limitation a tall oil itself, crude tall oil, distilled tall oil products, tall oil fatty acid (TOFA), tall oil distillation bottoms, and specialty tall oil products such as those provided by Georgia-Pacific Chemicals LLC, Atlanta, Ga. For example, tall oil distillation products having greater than about 90% tall oil fatty acid and less than about 6% rosin acid, such as XTOL® 100, XTOL® 101, XTOL® 300, and XTOL® 304; tall oil distillation products such as XTOL® 520, XTOL® 530 and XTOL® 542; tall oil distillation products having at least about 90% rosin acid and less than about 5% tall oil fatty acid, such as LYTOR® 100; oxidized crude tall oil compositions, such as XTOL® MTO; and blends thereof. In some implementations, such as when the tall oil product is purchased as an oxidized tall oil product, the product may be used without further modification.

Sources of fatty acids can include various amounts of the fatty acids, including various amounts of different fatty acids. In some implementations, a source of fatty acid can also include rosin acid. For example, TOFA can contain oleic acid, linoleic acid, and linolenic acid, as well as rosin acids, such as abietic and pimaric acid. In some implementations, the compositions may further include unsaponifiables or neutral compounds, such as hydrocarbons, higher alcohols, and sterols.

In some implementations, a blend of tall oil fatty acid and rosin acid can be used as the source of fatty acids to be oxidized. Such a blend can contain, for example, from about 20% to 99% tall oil fatty acid (e.g., 20%, 25%, 30%, 45%, 50%, 60%, 75%, 82%, 90%, and 99%). In some implementations, a blend can further contain about 1% to about 55% rosin acid (e.g., 1%, 2.5%, 5%, 10%, 15%, 20%, 25%, 30%, 40%, 50%, and 55%). In some implementations a blend can contain about 45% to about 90% tall oil fatty acid. In some implementations a blend can contain about 30% tall oil fatty acid and about 30% rosin acid. In another implementations, the ratio of tall oil fatty acid to rosin acid can be from about 3:2 to about 4:1 (e.g., 3:2, 4:2, 3:1, and 4:1).

The reaction product prepared by reacting at least one of a mono or dimer carboxylic acid with an ethyleneamine at conditions sufficient to cause the amino groups of the ethyleneamine to react with the acid group of the carboxylic acid may include at least one of dialkyl substituted imidazolines, dialkyl substituted amide-imidazoline, dialkyl substituted amides and monoalkyl substituted amides.

In some implementations, di-alkyl substituted imidazolines are defined by Formula (XIX):

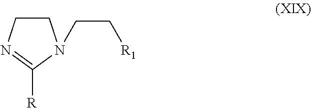

R is an alkyl or alkenyl group having 8 to 23 carbons (e.g., R is a C₁₅-C₁₈ alkenyl; R is a C₁₇ alkenyl).

In some implementations, the dialkyl substituted amides are defined by Formula (XX):

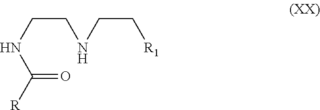

R is an alkyl or alkenyl group having 8 to 23 carbons (e.g., R is a C₁₅-C₁₈ alkenyl; R is a C₁₇ alkenyl). R₁ is a hydroxyl group or amino group.

In some implementations, the products formed are mixtures of imide and amide with the imide (or imidazoline) being the primary structure.

In some implementations where the ethyleneamine is a piperazine, the formed amide can be a monoalkyl substituted amide. Monoalkyl substituted amides are defined by Formula (XXI):

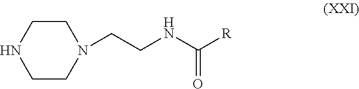

R is an alkyl or alkenyl group having 8 to 23 carbons (e.g., R is a C₁₅-C₁₈ alkenyl; R is a C₁₇ alkenyl).

The di-alkyl substituted imidazoline, amides and monoalkyl substituted amides are then reacted with a quaternization agent. Exemplary quaternization agents include dimethyl sulfate, diethyl sulfate, benzyl chloride, methyl chloride, dichloroethylether, other similar compounds and their mixtures. In some implementations, dimethyl sulfate and diethyl sulfate are the preferred quaternization agents.

The quaternized product may then be dissolved in a suitable solvent. Suitable solvents include water, methanol, ethanol, isopropanol, ethylene glycol, other similar compounds and their mixtures.

The quaternized dialkyl imidazolines, amides, monoalkyl substituted amides and their mixtures have been found to be excellent anti-agglomerate gas hydrate inhibitor in sour conditions, sweet conditions, 25% water cut and 100% water cut. Since they are also excellent corrosion inhibitors, the dialkyl imidazoline, amides, monoalkyl substituted amides and their mixtures simultaneously provide both corrosion protection and gas hydrate inhibition.

Various synthesis methodologies, which can be appreciated by one of ordinary skill in the art, can be utilized to make the claimed compositions. Detailed representative synthetic schemes are provided in the examples.

The compositions described herein can contain one or more additional chemistries. Various formulations can be appreciated by one of ordinary skill in the art and can be made without undue experimentation.

In some implementations, the compositions described herein further comprise at least one additional hydrate inhibitor.

In some implementations, the compositions described herein further comprise one or more thermodynamic hydrate inhibitors, one or more kinetic hydrate inhibitors, one or more anti-agglomerants, or a combination thereof.

In some implementations, the compositions described herein further comprise one or more asphaltene inhibitors, paraffin inhibitors, corrosion inhibitors, scale inhibitors, emulsifiers, water clarifiers, dispersants, emulsion breakers, or a combination thereof.

In some implementations, the compositions described herein further comprise one or more polar or nonpolar solvents or a mixture thereof.

In some implementations, the compositions described herein further comprise one or more solvents selected from isopropanol, methanol, ethanol, 2-ethylhexanol, heavy aromatic naphtha, toluene, ethylene glycol, ethylene glycol monobutyl ether (EGMBE), diethylene glycol monoethyl ether, xylene, or a combination thereof.

The compositions may be introduced into the fluid by any means suitable for ensuring dispersal of the inhibitor through the fluid being treated. Typically the inhibitor is injected using mechanical equipment such as chemical injection pumps, piping tees, injection fittings, and the like. The inhibitor mixture can be injected as prepared or formulated in one or more additional polar or non-polar solvents depending upon the application and requirements.

Representative polar solvents suitable for formulation with the inhibitor composition include water, brine, seawater, alcohols (including straight chain or branched aliphatic such as methanol, ethanol, propanol, isopropanol, butanol, 2-ethylhexanol, hexanol, octanol, decanol, 2-butoxyethanol, etc.), glycols and derivatives (ethylene glycol, 1,2-propylene glycol, 1,3-propylene glycol, ethylene glycol monobutyl ether, etc.), ketones (cyclohexanone, diisobutylketone), N-methylpyrrolidinone (NMP), N,N-dimethylformamide and the like.

Representative non-polar solvents suitable for formulation with the inhibitor composition include aliphatics such as pentane, hexane, cyclohexane, methylcyclohexane, heptane, decane, dodecane, diesel, and the like; aromatics such as toluene, xylene, heavy aromatic naphtha, fatty acid derivatives (acids, esters, amides), and the like.

In some implementations described herein, the disclosed composition is used in a method of inhibiting the formation of hydrate agglomerates in an aqueous medium comprising water, gas, and optionally liquid hydrocarbon. In some implementations, the gas comprises hydrogen sulfide. The method comprises adding to the aqueous medium an effective anti-agglomerant amount of the disclosed composition.

The compositions and methods described herein are effective to control gas hydrate formation and plugging in hydrocarbon production and transportation systems. To ensure effective inhibition of hydrates, the inhibitor composition should be injected prior to substantial formation of hydrates. One exemplary injection point for petroleum production operations is downhole near the surface controlled sub-sea safety valve. This ensures that during a shut-in, the product is able to disperse throughout the area where hydrates will occur. Treatment can also occur at other areas in the flowline, taking into account the density of the injected fluid. If the injection point is well above the hydrate formation depth, then the hydrate inhibitor should be formulated with a solvent with a density high enough that the inhibitor will sink in the flowline to collect at the water/oil interface. Moreover, the treatment can also be used for pipelines or anywhere in the system where there is a potential for hydrate formation.

In some implementations, the composition is applied to an aqueous medium that contains various levels of salinity. In some implementations, the fluid has a salinity of 0% to 35%, about 1% to 35%, or about 10% to 24% weight/weight (w/w) total dissolved solids (TDS). The aqueous medium in which the disclosed compositions and/or formulations are applied can be contained in many different types of apparatuses, especially those that transport an aqueous medium from one point to another point.

In some implementations, the aqueous medium is contained in an oil and gas pipeline. In other implementations, the aqueous medium is contained in refineries, such as separation vessels, dehydration units, gas lines, and pipelines.

In some implementations, the composition is applied to an aqueous medium that contains various levels of water cut. One of ordinary skill in the art would interpret water cut to mean the % of water in a composition containing an oil and water mixture. In some implementations, the water cut is from about 0.1 to about 100% v/v. In some implementations, the water cut is from about 25 to about 100% v/v. In some implementations, the water cut is about 25% v/v. In some implementations, the water cut is about 100% v/v.

The compositions described herein and/or formulations thereof can be applied to an aqueous medium in various ways that would be appreciated by of ordinary skill in the art. One of ordinary skill in the art would appreciate these techniques and the various locations to which the compositions or chemistries can be applied.

In one implementation, the compositions and/or formulations are pumped into the oil/gas pipeline by using an umbilical line. In a further implementation, capillary string injection systems can be utilized to deliver the compositions and/or formulations of the invention, in this case anti-agglomerants.

Various dosage amounts of a composition and/or formulation can be applied to the aqueous medium to inhibit the formation of hydrate agglomerates. One of ordinary skill in the art would be able to calculate the amount of anti-agglomerant for a given situation without undue experimentation. Factors that would be considered of importance in such calculations include, for example, content of aqueous medium, percentage water cut, API gravity of hydrocarbon, and test gas composition.

In some implementations, the dose range from the hydrate inhibitor that is applied to an aqueous medium is between about 0.01% and about 10%. In one implementation, the dose range for the hydrate inhibitor that is applied to an aqueous medium is between about 0.1% volume to about 3% volume based on water cut. In another implementation, the dose range is from about 0.25% volume to about 1.5% volume based on water cut.

### EXAMPLES

Objects and advantages of the implementations described herein are further illustrated by the following examples. The particular materials and amounts thereof, as well as other conditions and details, recited in these examples should not be used to limit the implementations described herein.

A description of the raw materials used in the examples is as follows:
325 Coco Fatty Acid A coconut fatty acid commercially available from Vantage Oleochemicals, Inc. of Chicago, Ill.
A-1328 A mixture of aminoethyl ethanolamine, N-(2-aminoethyl)piperazine and triethylenetetramine which is commercially available from Molex Company of Athens, Ala.
AEEA 2-[(2-aminoethyl)amino]-ethanol which is commercially available from Huntsman Corporation.
WCI 4713 A corrosion inhibitor commercially available from WEATHERFORD®.
DRILLSOL® PLUS A hydrocarbon drilling fluid commercially available from ENERCHEM International, Inc.
Ethyleneamine E-100 A mixture of TEPA, PEHA, HEHA, and higher molecular weight products with a number average molecular weight of 250-300 g/mole commercially available from Huntsman.
Emery 1003A A dimer-trimer acid commercially available from Emery Oleochemicals.
ENVIRODRILL® A mineral oil commercially available from WEATHERFORD®.
FRAC CLEAR™ An aromatic containing base oil having commercially available from WEATHERFORD®.
KHI1 Hydrate Inhibitor A hydrate inhibitor commercially available from WEATHERFORD®.
KHI2-KHI5 inhibitor A low dose gas hydrate inhibitor based on Poly Vinyl Caprolactam (VCap) commercially available.
UNIDYME® M-15 A dimerized fatty acid produced by the selective reaction of tall oil fatty acids mainly composed of C36 and C54 tricarboxylic acids commercially available from Arizona Chemical.
XTOL® 304 TOFA A light amber colored Tall Oil Fatty Acid produced from the fractional distillation of crude tall oil with 92% fatty acids min, 3.0% rosin max, ACV 193 min, color gardner 4 max commercially available from Georgia Pacific Chemical L.L.C.

### Example 1

8255 kilograms of tall oil fatty acid was added to a reactor equipped with temperature control, nitrogen blanket and purge capability, vacuum pump and trap. 2948 kilograms of N-(2-aminoethyl)ethanolamine (AEEA) was added to the reactor. The contents were heated to 163° C. with a nitrogen blanket until a Total Amine Value (TAV) of 140 to 155 was achieved. 236 additional kilograms of N-(2-aminoethyl)ethanolamine was added to reach the 140 to 155 TAV. The cook was continued at 163° C. until the acid number was below 10. After the acid number was below 10, another 236 kilograms of the AEEA was added to achieve a TAV of 173 to 183. The nitrogen blanket was turned off and nitrogen purge was turned on. The contents were heated to 191° C. The TAV was checked until the TAV was above 163. With FTIR, the imide/amide (I/A) ratio was checked. The cook was continued at 191° C. with a purge as long as TAV was decreasing and I/A ratio was increasing. Vacuum pump was turned on. A vacuum above 51 centimeters was achieved with purge still on. The contents were cooled under vacuum with purge. The final TAV was between 160 and 173. The final I/A ratio was between 3.0:1.0 to 10:00:1.0.

### Example 2

480 grams of the reaction product from Example 1 was added to a 1-liter resin kettle equipped with a thermocouple, thermocouple well, Vigreux distillation column and Friedrichs column on top. The contents were heated to 66° C. 152 grams of diethyl sulfate was added to reactor contents at 66° C. The temperature rose to 79° C. Diethyl sulfate addition was re-started after the temperature stopped rising. The temperature was maintained between 79° C. and 93° C. during most of the diethyl sulfate addition. When the reaction was complete, the TAV was below 30 and pH was between 7 and 9. The remaining 8 grams of diethyl sulfate was used to lower both the TAV and pH. If the pH was below 7.5 no diethyl sulfate was added. The contents were cooled down to 66° C. and 160 grams of methanol was added. The solids content was 80%.

### Example 3A

564 grams of oleic acid was added into a 1-liter resin kettle equipped with a thermocouple, thermocouple well, dean-stark trap, Vigreux distillation column and Friedrichs column on top. 236 grams of N-(2-aminoethyl)ethanolamine (AEEA) was added to the reactor contents. The reactor contents were heated to 163° C. with a nitrogen blanket. The cook was continued at 163° C. until acid number was below 10. TAV was between 173 to 183. The reactor contents were heated to 191° C. With FTIR, the imide/amide ratio was checked. The reactor contents were cooked at 191° C. with a nitrogen purge as long as TAV was coming down and I/A was going up. Contents were cooled with a purge. The amber liquid final TAV was between 160 and 173. Final I/A was between 3.0:1.0 to 10:00:1.0.

### Example 3B

456 grams of reaction product from Example 3A was added to a 1-liter resin kettle equipped with a thermocouple, thermocouple well, Vigreux distillation column and Friedrichs column on top. The contents were heated to 66° C. and that temperature stabilized. 184 grams of diethyl sulfate was added to reactor contents at 66° C. Temperature was maintained between 79° C. and 93° C. The temperature was controlled by feed rate and or use of cooling. When the reaction was complete, Total Amine Value (TAV) was 26.4 and pH was 6.65. The contents were cooled down to 66° C. and 160 grams methanol added. Solids content was 80%. Specific gravity was 0.974. Final product was a clear dark amber liquid.

### Example 4

520 grams of 325 Coco Fatty Acid was added into a 1-liter resin kettle equipped with a thermocouple, thermocouple well, dean-stark trap, Vigreux distillation column and Friedrichs column on top. 248 Grams of N-(2-aminoethyl)ethanolamine (AEEA) was added to the reactor contents. The reactor contents were heated to 163° C. with a nitrogen blanket. 16 Grams of additional N-(2-aminoethyl)ethanolamine was added. The cook was continued at 163° C. until the acid number was below 10. After the acid number was below 10, another 16 grams of the AEEA was added to achieve a TAV of 173 to 183. The nitrogen blanket was turned off and nitrogen purge turned on. The reactor contents were heated to 191° C. The TAV was checked. With FTIR, the imide/amide ratio was checked. The reactor contents were cooked at 191° C. with a purge as long as TAV was decreasing and the I/A ration was increasing. The contents were cooled with a purge. The final TAV was 215.

### Example 5

427 grams of the reaction product from Example 4 was added to a 1-liter resin kettle equipped with a thermocouple, thermocouple well, Vigreux distillation column and Friedrichs column on top. The contents were heated to 66° C. 205 grams of diethyl sulfate was added to the reactor contents at 66° C. Temperature rose to 79° C. Diethyl sulfate addition was re-started after the temperature stopped rising. The temperature was maintained between 79° C. and 93° C. during most of the diethyl sulfate addition. When the reaction was complete, the TAV was below 30 and pH was between 7-9. The remaining 8 grams of diethyl sulfate was used to lower both the TAV and pH. No diethyl sulfate was added if the pH was below 7.5. The contents were cooled down to 66° C. and 160 grams of methanol was added. The solids content was 80% and the pH was 7.5.

### Example 6

700.5 grams of tall oil fatty acid was added to a reactor equipped with temperature control, nitrogen blanket and purge capability, vacuum pump and trap. 250.5 grams A-1328 was added to the reactor. A-1328 is a blend of 65% N-(2-aminoethyl)ethanolamine, 23% N-(2-aminoethyl)piperazine, 1.4% 5-ethyl-1,4,7-triazabicyclo(4.3.0)non-4,6-diene, 0.8% 5-ethyl-1,4,7-triazabicyclo(4.3.0)non-6-ene and 10.2% triethylenetetramine. The contents were heated to 163° C. with a nitrogen blanket until a TAV of 140 to 155 was achieved. 20 grams of A-1328 was added to reach the 140 to 155 TAV. The cook was continued at 163° C. until the acid number was below 10. After the acid number was below 10, another 9 kilograms of the A-1328 was added to achieve a TAV of 175 to 185. The nitrogen blanket was turned off and nitrogen purge was turned on. The contents were heated to 191° C. The TAV was checked every hour and TAV was kept above 175. With FTIR, the imide/amide (I/A) ratio was checked. The cook was continued at 191° C. with a purge as long as TAV was decreasing and the I/A ratio was increasing. Vacuum pump was turned on. A vacuum above 51 centimeters was achieved with purge still on. The contents were cooled under vacuum with purge. The final TAV was between 175 and 185. The final I/A ratio was between 1.5 to 2.5.

### Example 7

580 grams of the reaction product from Example 6 was added to a 2-liter resin kettle equipped with a thermocouple, thermocouple well, Vigreux distillation column and Friedrichs column on top. The contents were heated to 66° C. 220 grams of diethyl sulfate was added dropwise to reactor contents at 66° C. The temperature rose to 79° C. Diethyl sulfate addition was re-started after the temperature stopped rising. The temperature was maintained between 79° C. and 93° C. during most of the diethyl sulfate addition. When the reaction was complete, the TAV was 23 and the pH was 6.5. The contents were cooled to 66° C. and 200 grams of methanol was added. The solids content was 80%.

### Example 8

523.15 grams of Tall Oil Fatty Acid was added into a 1-liter resin kettle equipped with a thermocouple, thermocouple well, dean-stark trap, Vigreux distillation column and Friedrichs column on top. 269.00 grams of N-(2-aminoethyl)piperazine was added to the reactor contents. The reactor contents were heated to 149° C. with a nitrogen blanket. The cook was continued at 157° C. where overheads started to collect. The TAV was 241 and the Acid Number (AN) was 15. After the acid number was below 10, the temperature was raised to 207° C. The TAV was 223 and the AN was 5.7. With FTIR, intense bands were present at 1647 and 1547 cm⁻¹.

368 grams of the amide from N-(2-aminoethyl)piperazine and tall oil fatty acid was left in the 1 liter resin kettle equipped with a thermocouple, thermocouple well, Vigreux distillation column and Friedrichs column on top. The reactor contents were heated to 81° C. 280.45 grams of diethyl sulfate was added to an addition funnel and added to the reactor contents dropwise with a nitrogen blanket. All of the diethyl sulfate was added in 146 minutes while maintaining the reaction temperature between 81° C. to 112° C. The reactor contents were maintained at a temperature between 84° C. and 117° C. for 130 minutes and then cooled to 83° C. where 152.00 grams of isopropanol and 50.02 grams of water was added. The final product was a transparent amber liquid with a specific gravity of 1.037.

### Example 9

616.07 grams of Tall Oil Fatty Acid was added into a 1-liter resin kettle equipped with a thermocouple, thermocouple well, dean-stark trap, Vigreux distillation column and Friedrichs column on top. 184.17 grams of triethylenetetramine (TETA) was added to the reactor contents. The reactor contents were heated to 82° C. with a nitrogen blanket. The temperature controller limit was raised in 4° C. increments until 147° C. was reached. Overheads started to collect in the dean stark trap at 147° C. A considerable amount of water was collected at 163° C. The temperature was incrementally increased. At 180° C., the TAV was 175 and the Acid Number (AN) was 16. At 190° C., the acid number was below 9.9 and the TAV was 175. The temperature was incrementally raised to 260° C. where the TAV was 176 and the AN was 4.3. With FTIR, intense bands were present at 1670 cm⁻¹ (amide) and 1609 cm⁻¹ (imide). The imide to amide (I/A) ratio was 0.59 by FTIR. After 5 hours and five minutes between 258° C. and 262° C., the I/A ratio was 6.7, the AN was 3.5 and the TAV was 174.

### Example 10

500.25 grams of the imide/amide product from the reaction of triethylenetetramine and tall oil fatty acid in Example 9 was left in the 1 liter resin kettle equipped with a thermocouple, thermocouple well, Vigreux distillation column and Friedrichs column on top. The reactor contents were heated to 70° C. Diethyl sulfate (138.3 grams; 120 mls) was added to an addition funnel and added to the reactor contents dropwise with a nitrogen blanket. All of the diethyl sulfate was added in 115 minutes while maintaining the reaction temperature between 88° C. to 101° C. The reactor contents was maintained at a temperature between 95° C. and 106° C. for 183 minutes and then cooled to 56° C. where methanol (155 grams) and isopropanol (127 grams) were added. The final product was a transparent amber liquid with a specific gravity of 0.9355.

### Example 11

10,995 kilograms of tall oil fatty acid was added to a reactor equipped with temperature control, nitrogen blanket and purge capability, vacuum pump and trap. 3,520 kilograms of diethylenetriamine (DETA) was added to the reactor. The contents were heated to 163° C. with a nitrogen blanket until a TAV of 235-250 and acid number of 2-4 was achieved. The contents were heated to 274° C. With FTIR, the imide/amide ratio was checked until the I/A ratio was above 2:1. The final TAV was between 205 and 220.

### Example 12

480.1 grams of the imide/amide product from the reaction of diethylenetriamine and tall oil fatty acid in Example 11 were charged into a 1 liter resin kettle equipped with a thermocouple, thermocouple well, dean-stark trap, Vigreux distillation column and Friedrichs column on top. The reactor contents were heated to 81° C. under a nitrogen blanket. Diethyl sulfate (160.33 grams; 135 mls) was added to an addition funnel and added to the reactor contents dropwise under the nitrogen blanket. All of the diethyl sulfate was added in 113 minutes while maintaining the reaction temperature between 88° C. to 103° C. The reactor contents were maintained at a temperature between 93° C. and 103° C. for 200 minutes and then cooled to 64° C. where methanol (160 grams) was added. The final product was a transparent amber liquid with a specific gravity of 0.965 and pH of 7.3.

### Example 13

915 grams of Tall Oil Fatty Acid, 135 grams UNIDYME® M-15 and 15 grams butylated hydroxytoluene were added into a 2-liter resin kettle equipped with a thermocouple, thermocouple well, dean-stark trap, Vigreux distillation column and Friedrichs column on top. 375 Grams of N-(2-aminoethyl)ethanolamine (AEEA) was added to the reactor contents. The reactor contents were heated to 82° C. with a nitrogen blanket. The temperature controller limit was raised in 4° C. increments until 147° C. was reached. Overheads started to collect in the dean stark trap at 147° C. Considerable water collected at 163° C. The temperature was incrementally increased. At 180° C., the Total Amine Value (TAV) was 174 and the Acid Number (AN) was 30. 30 grams of N-(2-aminoethylethanolamine) was added. TAV was 176 and acid number was 10. 15 more grams of N-(2-aminoethylethanolamine) was added. TAV was 177 and acid number was zero. The temperature was incrementally raised to 260° C. where the final TAV was 167 and the AN was 3.5 to 1.

### Example 14

The imide/amide from N-(2-aminoethylethanolamine) and tall oil fatty acid (500.25 grams) from the Example 13 was left in the 1 liter resin kettle equipped with a thermocouple, thermocouple well, Vigreux distillation column and Friedrichs column on top. The reactor contents were heated to 70° C. Diethyl sulfate (166.75 grams) was added to an addition funnel and added to the reactor contents drop wise with a nitrogen blanket. All of the diethyl sulfate was added over a period of 115 minutes while maintaining the reaction temperature between 88° C. to 101° C. The reactor contents were maintained at a temperature between 95° C. and 106° C. for 183 minutes and then cooled to 56° C. where diethylene glycol (166.75 grams) was added. The final product was an amber liquid with a specific gravity of 1.03, pH 7.7 and TAV of 23.

### Example 15

480.12 grams (1.28 moles) of Example 1 was added into a 1-liter kettle equipped with a thermocouple, thermocouple well, and reflux condenser. The reactor contents were heated to 66° C. 74.25 grams dichloroethylether (0.52 moles) was added to the reactor contents at 66° C. or hotter. The reactor contents were maintained at a temperature under between 102° C. and 110° C. and then held at above 102° C. for 8-12 hours. 148.75 grams of methanol was added to the reactor contents to provide a solids content of 80%.

### Example 16

1.5 grams of KHI4 inhibitor was weighed into a dish and % solids content. was determined. The resulting crystalline solid was scrapped into 250 ml beaker and TAV was determined. % Solids was 39.72 wt. %. TAV was 26.62.

242.99 grams (0.574 moles) of KHI4 inhibitor and 100 grams of deionized water were added into a 500 ml kettle equipped with a thermocouple, thermocouple well, and Vigreux Distillation Column and Friedrichs Condenser on top. The reactor contents were heated to 32° C. 35.87 grams (0.233 moles) diethyl sulfate was added drop wise from an addition funnel to reactor contents maintained at a temperature between 49° C. and 61° C. with a nitrogen purge assembly. The batch was maintained at a temperature between 84° C. and 86° C. for 7 hours and 10 minutes to provide a dark honey brown viscous transparent liquid with 41% solids content. The final product is represented by formula (XXII). In some implementations of formula (XV) n=1; m=10 to 40 and o=5 to 20. In some implementations of formula (XXII) n=1; m=20 to 30 and o=9 to 10.

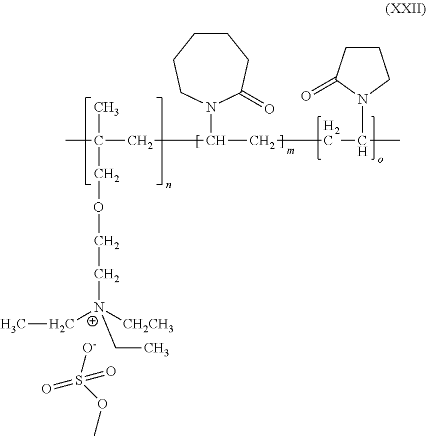

### Example 17

277 grams (1.20 moles) tetrahydroxyethyl diethylenetriamine (THEDEA) and 413 grams water were added into a 1 liter resin kettle equipped with a thermocouple, thermocouple well, Vigreux distillation column and Friedrichs column on top. The reaction mixture was agitated and heated to 79° C. 310 grams (2.01 moles) of diethyl sulfate were added drop wise from addition funnel in 90 minutes. The reactor contents were an orange to red transparent liquid. The reaction mixture was maintained at a temperature between 79° C. and 93° C. for 4 hours. The final product had 56% solids and had a TAV of 9.

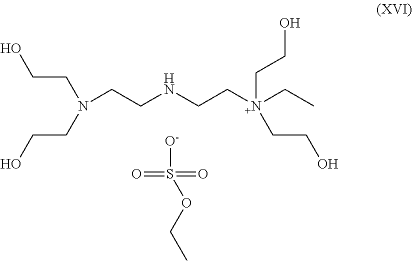

### Example 18

A blend of 1.5 wt. % of the final product Example 2 and 1.5 wt. % of the final product of Example 10.

### Example 19

A blend of 1.5 wt. % of the final product of Example 2, 0.75 wt. % of the final product of Example 12 and 0.75 wt. % of the final product of Example 10.

### Example 20

A blend of 1.5 wt. % of the final product of Example 2 and 1.5 wt. % of the final product of Example 12.

Results:

For testing to begin in a laboratory, a base line or control was done to actually form hydrates under different conditions in order to test the selected chemicals. Sweet conditions were used initially and then adapted to sour conditions (H₂S). Autoclaves were set up to safely accommodate sour working conditions. Hydrates with maximum torque >8 N·cm were formed for the control. Maximum torque is the point of highest potential for hydrate agglomeration or blockage. The maximum torque obtained after using the hydrate inhibitor (kinetic hydrate inhibitor or anti-agglomerant) was compared to the control.

Testing for Sweet Systems. The hydrate inhibitor was made up to 200 mL of mixture DRILLSOL® PLUS-tap water (75:25) to 100% tap water. The autoclave was flushed with N₂ gas (80 psi×3). Sweet gases were then added to autoclave to 1100-1900 psi. The test program was then started: 150 to 800 rpm, equilibration for 1 hour; temperature drop 20 to 4° C. for 1½ hours; shut in for 30 minutes at 4° C. (no stirring) and constant temperature at 4° C. for 30 minutes (total 3 hours). Pressure, temperature and torque were recorded. The control is without inhibitor.

Testing for Sour Systems: The Inhibitor was made up to 200 mL of mixture DRILLSOL® PLUS-tap water (75:25) to 100% tap water. The autoclave was flushed with N₂ gas (80 psix 3). Sour gases containing 0.4-4% H₂S was added to the autoclave. The test program was then started: 150-800 rpm, equilibration for 1 hour; temperature drop 20 to 4° C. for 1½ hours; shut in for 30 min at 4° C. and constant temperature and stirring at 4° C. for 30 minutes (total 3 hours). Pressure, temperature and torque were recorded. Pressure, temperature and torque were recorded. Control is without inhibitor.

Long test (24 h shut down) sour system: The Inhibitor was made up to 200 mL of mixture DRILLSOL® PLUS-tap water (75:25) to 100% tap water. The autoclave was flushed with N₂ gas (80 psix 3). Sour gases containing 0.4-4% H₂S was added to the autoclave. The test program was then started: 150-800 rpm, equilibration for 1 hour; temperature drop 20 to 4° C. for 1½ hours; shut in for 30 min at 4° C.; constant temperature at 4° C. for 30 minutes; reheat to 15-20° C.; cool to 4° C.; shut in for 24 hour and constant temperature and stirring for 30 min (total 32 hours). Pressure, temperature and torque were recorded. Control as above with no inhibitor.

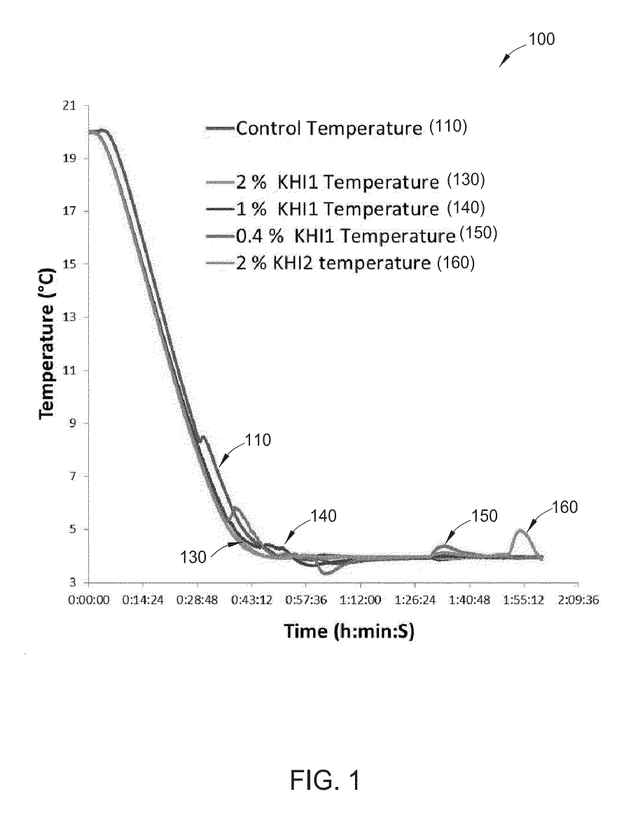

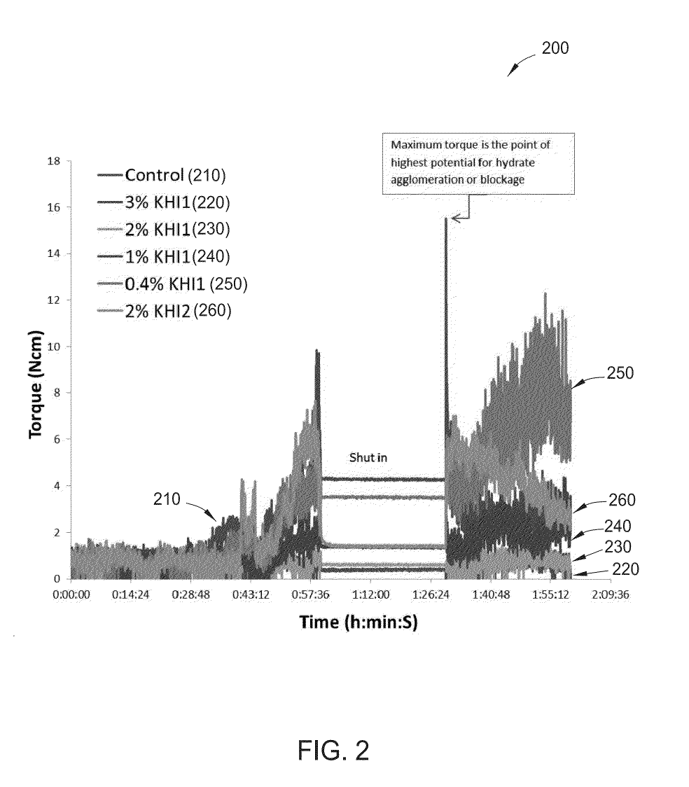

FIG. 1 depicts a plot 100 illustrating the temperature profile for kinetic hydrate inhibitors 0.4% KHI1 150, 1% KHI1 140, 2% KHI1 130 and 2% KHI2 inhibitor 160. FIG. 2 depicts a plot 200 illustrating the torque values for 3% KHI1 220, 2% KHI1 230, 1% KHI1 240, 0.4% KHI1 250 and 2% KHI2 260. FIG. 1 and FIG. 2 depicts sweet system (methane only) at 1700 psi (150 rpm), representing a subcooling of ˜12° C. The KHI test contained 0.4-3% (active/water phase) of KHI1 and 2% KHI2 (neat/water phase). The controls included no inhibitor. A small peak representing an exothermic reaction was noted at the end of nucleation or hydrate crystallization (at ˜8.5° C., for the control). No exotherm was observed for tests except for 1% KHI1 (FIG. 1). Torque values increased as the concentration of KHI1 decreased. Significant agglomeration was observed at 1% KHI1 as indicated by the increase in torque up to 12 N·cm compared to control 210 at maximum 16 N·cm (FIG. 2).

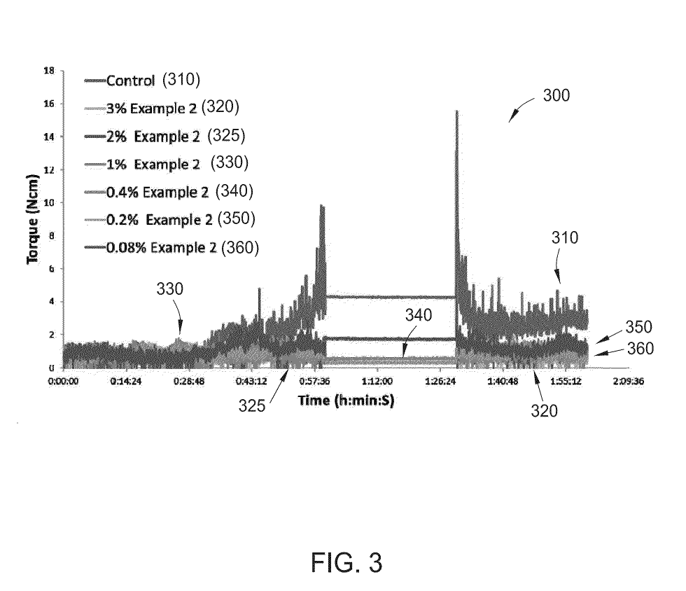

FIG. 3 depicts a plot 300 illustrating the torque values obtained for the composition of Example 2 applied in a sweet system (methane only) at 1700 psi in DRILLSOL® PLUS-tap water (75:25) (150 rpm). The composition of Example 2 was applied at 0.08-3% active/water phase. The control did not include any inhibitor. As shown in FIG. 3, torque values remained low (<3 N·cm) for 0.08-3% (320, 325, 330, 340, 350, 360) of Example 2 compared to the high maximum torque value (16 N·cm) for the control 310.

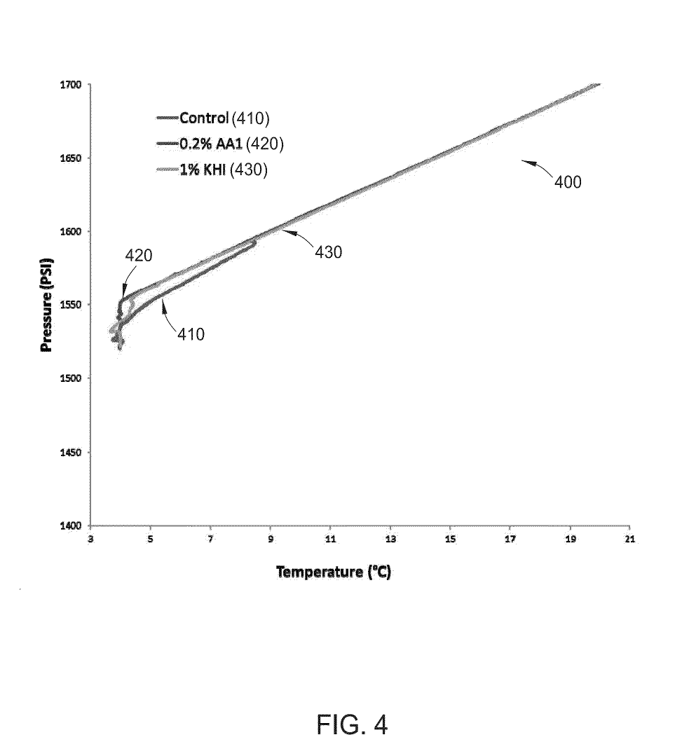

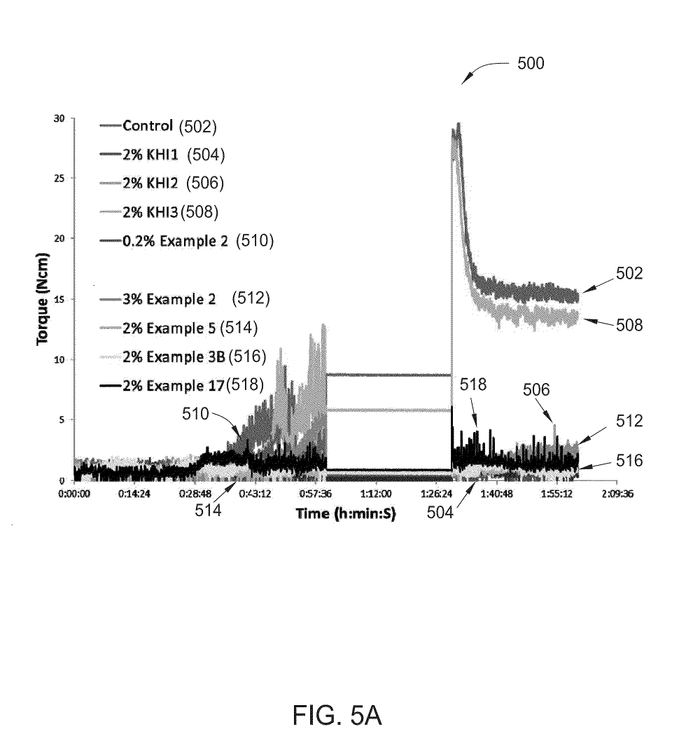

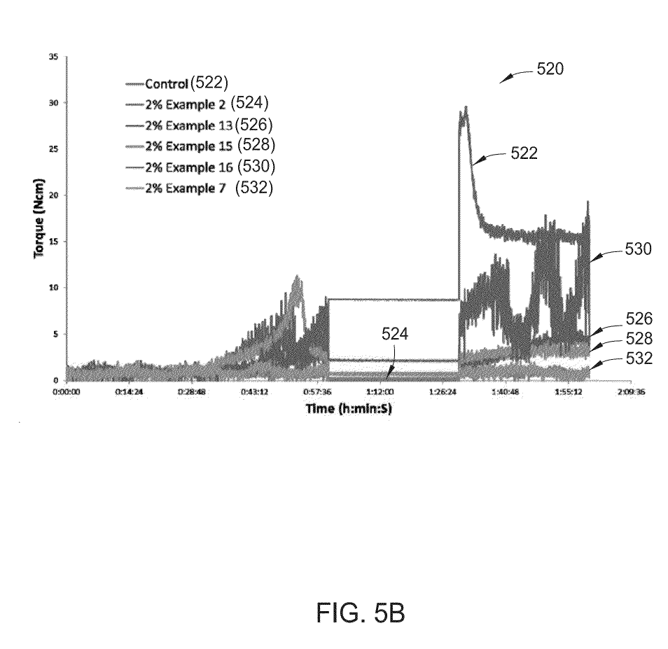

FIG. 4 depicts a plot 400 illustrating exotherms (in 1700 PSI, 4-20° C., methane-only system) for KHI1 (430) and Example 2 (420). As shown in FIG. 5A, 2% KHI1 (active/water phase) and example 2 delayed hydrate deposition or crystallization compared to the control

FIGS. 5A-5B depict plots 500, 520 illustrating the torque values for various kinetic hydrate inhibitors and anti-agglomerants in a sour system (0.4% H₂S and 99.6% methane environment at 150 rpm, 1700 psi in DRILLSOL® PLUS-tap water (75:25), ˜12 C subcooling). In the sour test with 0.4% H₂S and 99.6% methane, 2° A) KHI1 (active) (504), 2% KHI2 (506), 2% KHI3 (508), 0.2% Example 2 (510), 3° A) Example 2 (512), 2% Example 5 (514), 2% Example 3B (516), 2% Example 17 (518), 2% Example 13 (526), 2% Example 15 (528), 2% Example 16 (530) and 2° A) Example 7 (532) (neat, per water phase) were compared as shown in FIG. 5A and FIG. 5B. As shown in FIG. 5A, 0.2% Example 2, Example 3B and Example 5 when applied neat in sour conditions discouraged agglomeration as shown by the low torque values as compared to the control. Increasing or decreasing the amount of Example 2 did not improve its activity. Further, as shown in FIG. 5A, 2% KHI3 (neat/waterphase) was not effective in preventing hydrate formation or agglomeration. As shown in FIG. 5B, Example 7 resulted in lower torque values while Example 13, Example 15 and Example 16 resulted in higher torque values. In later analyses Example 5 resulted in increased torque as H₂S increased.

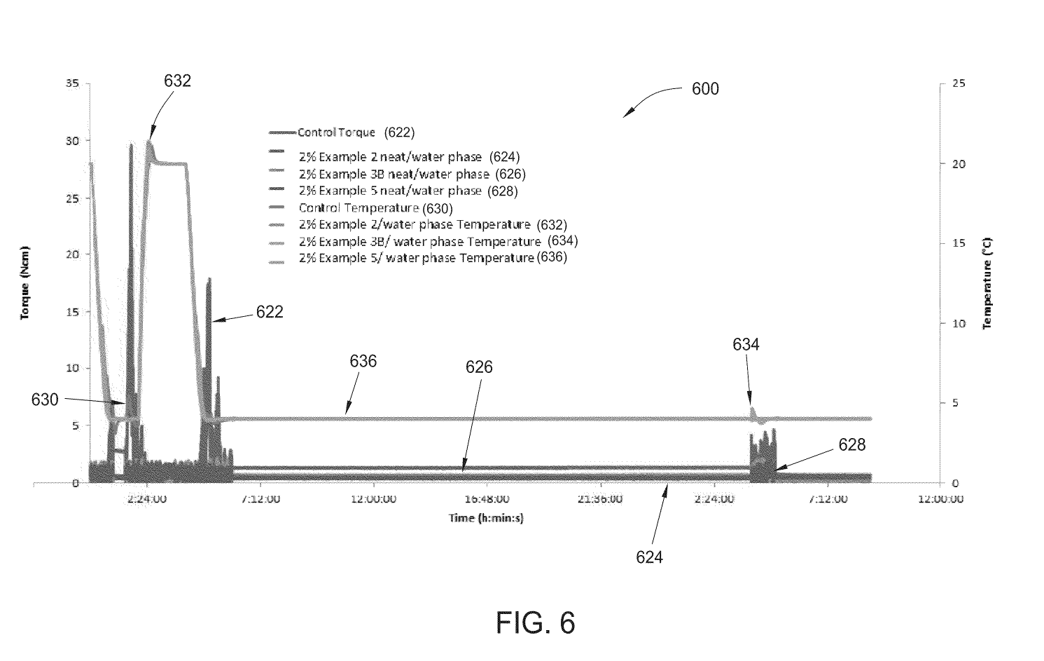

FIG. 6 depicts a plot 600 illustrating the torque values for selected inhibitors (applied neat) in a 24 hour shut-down system in DRILLSOL® PLUS-tap water (75:25) and 0.4% H₂S and 99.6% methane at 1700 psi (150 rpm). The selected inhibitors include 2% Example 2 (624, 632), 2% Example 3B (626, 634) and 2% Example 5 (628, 636). The program involved reheating back to 20° C., decreasing to 4° C. and subsequently no stirring for 24 hours. As shown in FIG. 6, the inhibitors maintained their effectiveness.

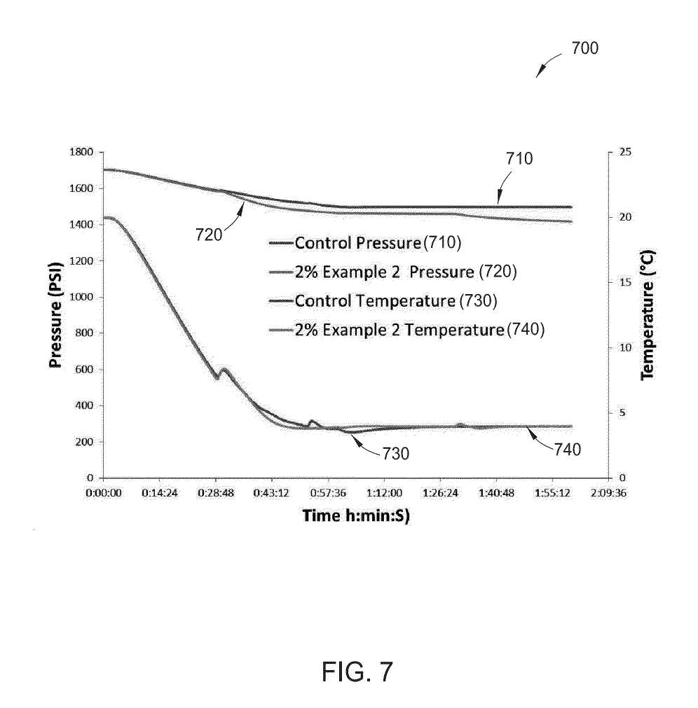

FIG. 7 depicts a plot 700 illustrating the pressure drop compared to temperature change for the control and Example 2. The change in pressure of the control is represented by line 710 and the change in temperature of the control is represented by line 730. The change in pressure for 2% of Example 2 is represented by line 720 and the change in temperature for 2% of Example 2 is represented by line 740. Pressure drops were observed in both the control and the tests. As shown in FIG. 7, there is a pressure drop at an exotherm and a pressure drop prior to experimental start. The extent of the pressure drop prior to experimental start varied according to the inhibitor.

The observed exotherms (Table I) occur at hydrate deposition or crystallization and may be an indication of whether the KHI is working or not in the set up (DRILLSOL® PLUS-tap water (75:25) and 0.4% H₂S and 99.6% methane at 1700 psi).

TABLE I

| | Approximate |
|---|---|
| Test | Exotherm (° C.) |
| Control | 8.5 |
| 3% Example 2 | 10 |
| 2% Example 2 | 8.5 |
| 2% Example 3B | 6 |
| 2% KHI2 | 4 |

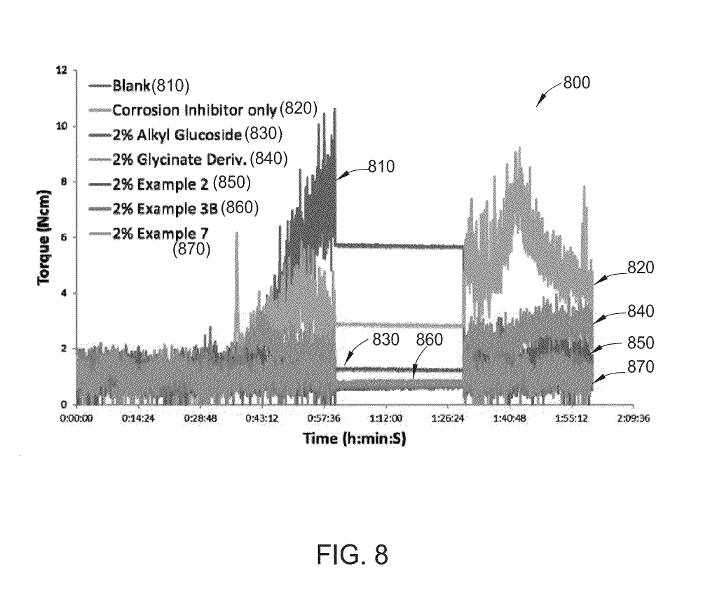

FIG. 8 depicts a plot 800 illustrating the torque values obtained for various anti-agglomerants with a corrosion inhibitor in 1% H₂S, 3% carbon dioxide and 96% methane (DRILLSOL® PLUS-tap water (75:25) (200 mL); 1915 psi, 20-4° C., 150 rpm). The torque values were obtained for 2% Alkyl Glucoside (830), 2% Glycinate Derivative (840), 2% Example 2 (850), 2% Example 3B (860) and 2% Example 7 (870). The Alkyl Glucoside based non-ionic surfactant (hereafter Alkyl Glucoside), Example 2, Example 3B and Example 7 (all applied neat) were effective antiagglomerants (AAs) resulting in torque values less than 2.5 N·cm compared to corrosion inhibitor (“CI”) only (9.2 N·cm) and the control (12.2 N·cm), causing significant decrease in torque compared to the blank and control (Table II). AAs remained effective with CI (500 ppm WCI 4713). As shown in Table II, as the concentration of AAs decreased the torque values increased.

TABLE II

| Test | Maximum Torque (N · cm) |
|---|---|
| Pre-test stirring of fluid (no hydrates) | 1.9 |
| Control | 12.5 |
| Corrosion Inhibitor (CI) Only | 9.2 |
| AAs/water phase | |
| 2% Example 2 | 2.35 |
| 2% Example 2 with 500 ppm Cl | 2.0 |
| 1% Example 2 with 500 ppm Cl | 2.4 |
| 0.5% Example 2 with 500 ppm Cl | 3.25 |
| 2% Alkyl Glucoside | 2.25 |
| 2% Alkyl Glucoside with 500 ppm Cl | 2.4 |
| 1% Alkyl Glucoside with 500 ppm Cl | 2.8 |
| 0.5% Alkyl Glucoside with 500 ppm Cl | 3.4 |
| 2% Glycinate Derivative | 2.75 |
| 2% Glycinate Derivative with 500 ppm Cl | 3.7 |
| 2% Example 3B with 500 ppm Cl | 2.2 |
| 1% Example 3B with 500 ppm Cl | 2.25 |
| 0.5% Example 3B with 500 ppm Cl | 3.4 |
| 2% Example 7 with 500 ppm Cl | 2.2 |
| 1% Example 7 with 500 ppm Cl | 3.6 |

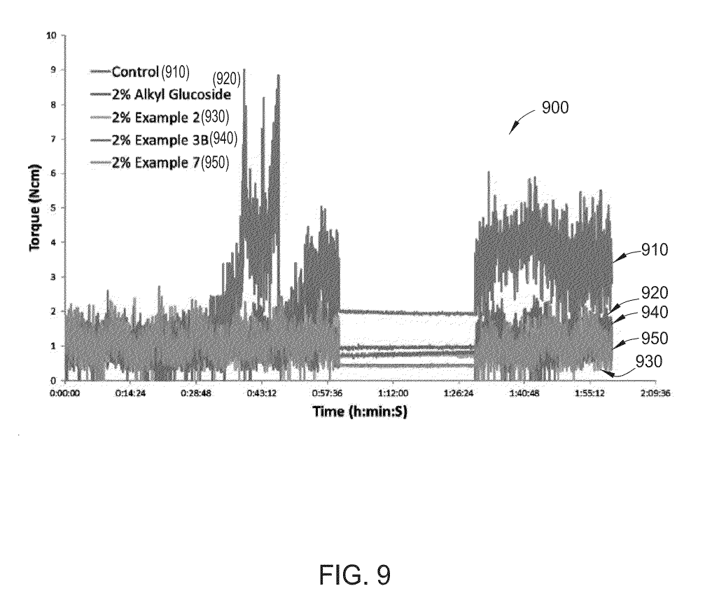

FIG. 9 depicts a plot 900 illustrating the torque values obtained for various anti-agglomerants in 2% H₂S, 3% carbon dioxide and 95% methane (DRILLSOL® PLUS-tap water (75:25) (200 mL); 1915 psi, 20-4° C., 150 rpm). Torque values were obtained for a control (910), 2% Alkyl Glucoside (920), 2% Example 2 (930), 2% Example 3B (940), and 2% Example 7 (950). As shown in FIG. 9, increasing the percentage of H₂S to 2% did not affect the performance of Example 2, Example 3B and Example 7 (applied neat at 2% per water phase). The maximum torque obtained was 2.6 N·cm compared to 8.8 N·cm for the control. There was a small increase in torque for Alkyl Glucoside (3.3 N·cm) compared to using 1% H₂S (2.3 N·cm).

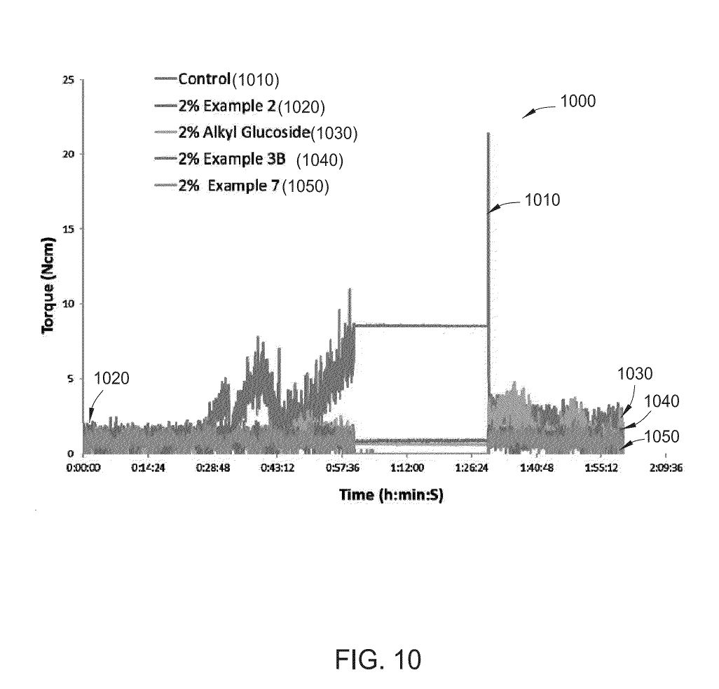

FIG. 10 depicts a plot 1000 illustrating the torque values obtained for various anti-agglomerants in 4% H₂S, 3% carbon dioxide and 93% methane (DRILLSOL® PLUS-tap water-(75:25) (200 mL); 1915 psi, 20-4° C., 150 rpm, ˜17 C subcooling). The torque values were obtained for a control (1010), 2% Example 2 (1020), 2% Alkyl Glucoside (1030), 2% Example 3B (1040) and 2% Example 7 (1050). As shown in FIG. 10, increasing the percentage of H₂S to 4% did not affect the performance of Example 2, Example 3B and Example 7 in this system. The maximum torque for the AAs was 2.2 N·cm compared to maximum 22 N·cm for the control. There was a small increase in torque for Alkyl Glucoside (4.7 N·cm) compared to using 2% H₂S (3.3 N·cm).

As shown in Table III, a sour and sweet gas mixture was obtained which contained gases prone to form type I and type II hydrates. Overall it was expected that the more stable type II hydrates would be formed.

TABLE III

| | 1% H₂S Mixed | Sweet Mixed |
|---|---|---|
| Gases | Gases | Gases |
| C₄H₁₀ | 1 | 1 |
| CO₂ | 3 | 3 |
| C₂H₆ | 12.5 | 12.5 |
| H₂S | 1 | None |
| N₂ | 1.3 | 1.3 |
| C₃H₈ | 3 | 3 |
| CH₄ | 78.2 | 79.2 |

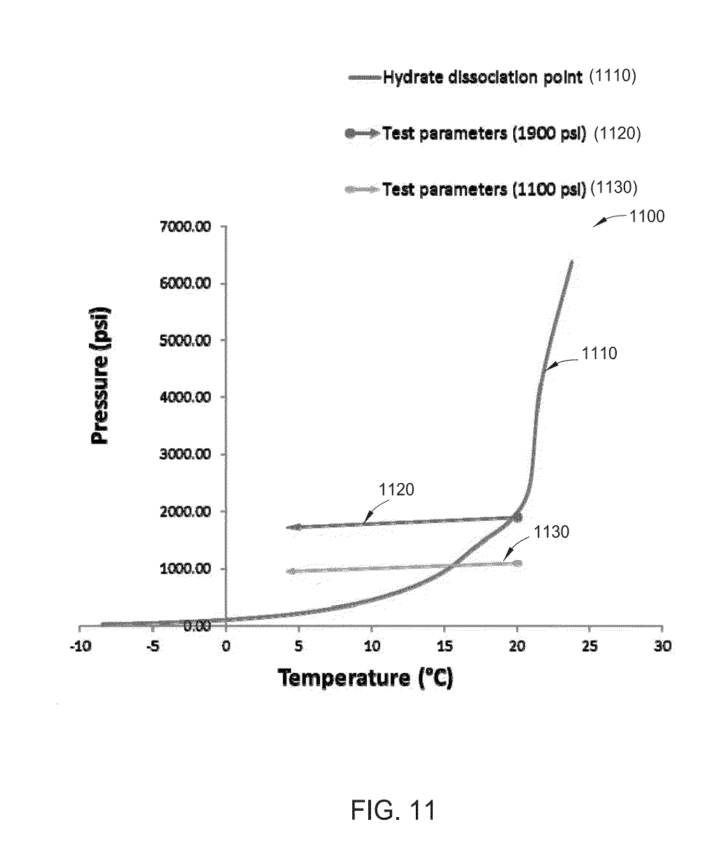

FIG. 11 depicts a plot 1100 illustrating the results of hydrate prediction software. ReO/PVTflex™ Compositional and Black-Oil Analysis software, commercially available from Weatherford™, predicted the beginning of the hydrate forming region for 1% H₂S mixed gases (Table III) at 1100 psi and 1900 psi. As shown in FIG. 11, this may suggest a sub-cooling of ˜12 and 15° C.

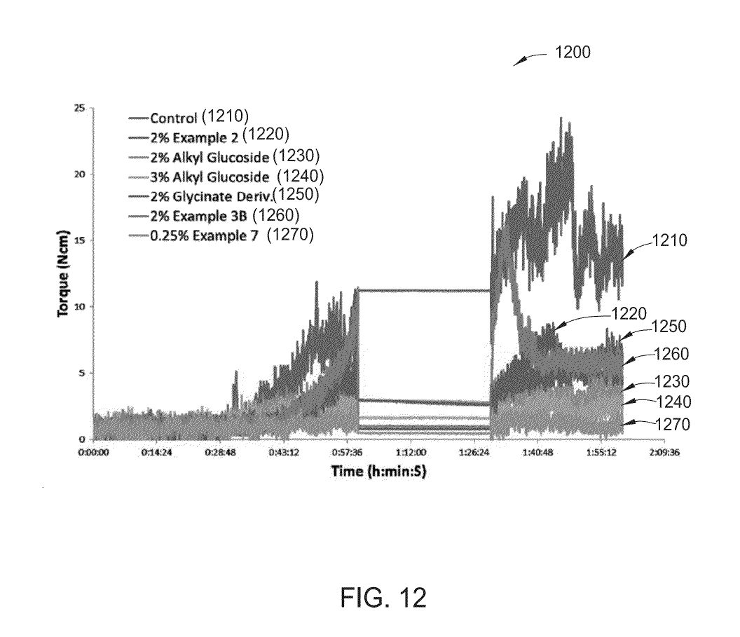

FIG. 12 depicts a plot 1200 illustrating the torque values obtained for various anti-agglomerants in 25% water cut and 1% H₂S mixed gases (Table III) (DRILLSOL® PLUS: tap water (75:25) (200 mL); 1100 psi, 20-4° C., 150 rpm, ˜12° C. subcooling). The torque values were obtained for a control (1210), 2% Example 2 (1220), 2% Alkyl Glucoside (1230), 3% Alkyl Glucoside (1240), 2% Glycinate Deriv. (1250), 2% Example 3B (1260) and 0.25% Example 7 (1270). As shown in FIG. 12, the composition of Example 7 was effective at <0.25% (applied neat, per water phase) as an anti-agglomerant recording a maximum torque of 2.5 N·cm, compared to a maximum torque of 25 N·cm for the control in condensate: tap water (75:25). At 2%, Alkyl Glucoside, Glycinate Derivative and Example 2 (applied neat) were able to lower torque (maximum 5.2, 8.3 and 8.7 N·cm respectively) compared to the control. Increasing Alkyl Glucoside to 3% improved torque slightly (3.8 N·cm) while increasing Example 2 to 4% caused an increase in torque to 17 N·cm (not shown). 2° A) Example 3B was not effective.

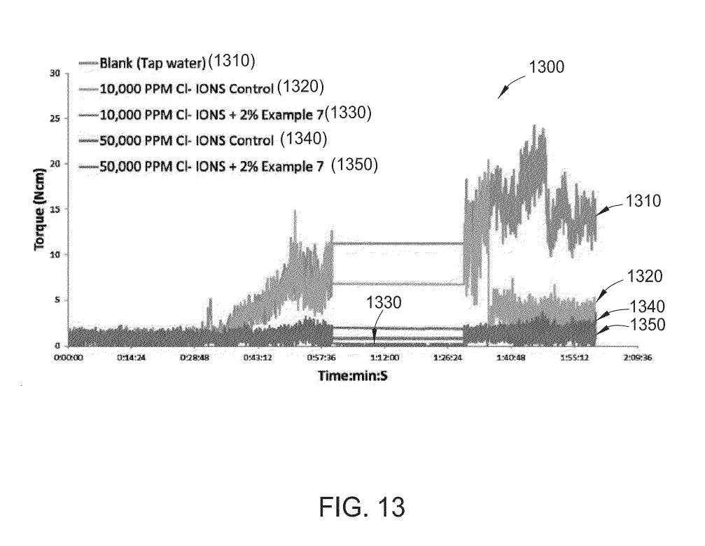

FIG. 13 depicts a plot 1300 illustrating the torque values obtained for Example 7 in condensate brine and 1% H₂S mixed gases (DRILLSOL® PLUS: brine (75:25) (10,000 and 50,000 Cl⁻ brine) (200 mL); 1100 psi, 20-4° C., 150 rpm). The torque values were obtained for tap water (1310), a 10,000 PPM chloride ion control (1320), 10,000 PPM chloride ions+2% Example 7 (1330), a 50,000 PPM chloride ion control (1340) and 50,000 PPM chloride ions+2% Example 7 (1350). As depicted in FIG. 13, increasing salinity decreased the agglomeration of hydrates. Example 7 (2%/water phase) remained effective in both 10,000 ppm and 50,000 ppm Cl⁻ ions in condensate:brine (75:25).

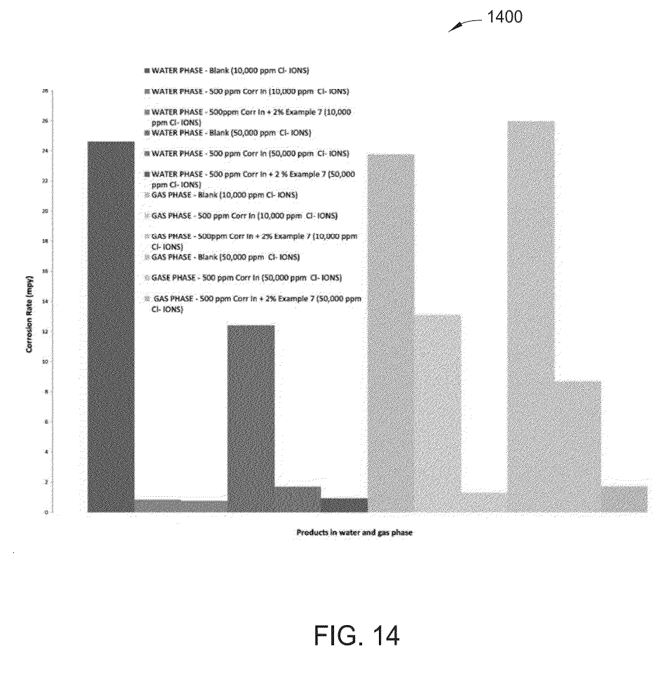

FIG. 14 depicts a plot 1400 illustrating the effect of Example 7 on corrosion rate in comparison with a commercially available corrosion inhibitor (10,000 and 50,000 Cl⁻ brine=270 ml (other=240 mL brine and 30 mL DRILLSOL® PLUS (89% water cut)); 1000 psi of gases (4% H₂S, 3% CO₂, 93% CH₄), 20° C.; 60 rpm). Corrosion rates for 100% water cut system with 10,000 and 50,000 ppm Cl⁻ ions was 24 mpy and 12.41 mpy, respectively, in the water phase at 1000 psi and 20° C. In 10,000 ppm Cl⁻, 2% Example 7/water phase caused further decrease in the corrosion rate (0.75 mpy) compared to the system with the corrosion inhibitor only (500 ppm WCI 4713, 0.84 mpy). At 50,000 ppm Cl⁻ the corrosion rate was also decreased further in the presence of Example 7 (0.9 mpy) compared to the system with Cl⁻ only (1.70 mpy). Some pitting was visible with corrosion inhibitor only. No pitting occurred when Example 7 was present. In the gas phase, Example 7 caused significant reduction in the corrosion rate. The results from using 100% water cut were comparable to 89% water cut.

Table IV depicts the water analysis for 10,000 ppm Cl⁻ brine used. Table V depicts the water analysis for 50,000 ppm Cl⁻ brine used.

TABLE IV

| Water Analysis | | Ion | | Use for 4 Liters |
|---|---|---|---|---|
| (ppm) | Ion | FW | Compound | (g) |
| 219 | Ca | 40.08 | CaCl₂•2H₂O | 3.200 |
| 51 | Mg | 24.31 | MgCl₂•6H₂O | 1.720 |
| 9 | Sr | 87.62 | SrCl₂•6H₂O | 0.120 |
| 0 | Ba | 137.27 | BaCl₂•2H₂O | 0.000 |
| 689 | SO₄ | 96.06 | Na₂SO₄ | 4.080 |
| 368 | HCO₃ | 61.02 | NaHCO₃ | 2.040 |
| 10000 | Cl | 35.45 | NaCl | 62.320 |

TABLE V

| Water Analysis | | Ion | | Use for 4 Liters |
|---|---|---|---|---|
| (ppm) | Ion | FW | Compound | (g) |
| 219 | Ca | 40.08 | CaCl₂•2H₂O | 3.200 |
| 51 | Mg | 24.31 | MgCl₂•6H₂O | 1.720 |
| 9 | Sr | 87.62 | SrCl₂•6H₂O | 0.120 |
| 0 | Ba | 137.27 | BaCl₂•2H₂O | 0.000 |
| 689 | SO₄ | 96.06 | Na₂SO₄ | 4.080 |
| 368 | HCO₃ | 61.02 | NaHCO₃ | 2.040 |
| 50000 | Cl | 35.45 | NaCl | 326.080 |

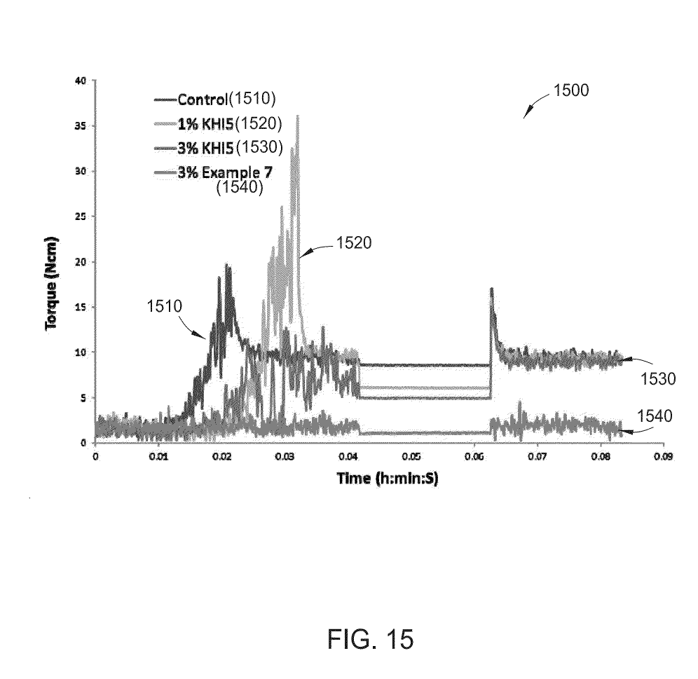

FIG. 15 depicts a plot 1500 illustrating the torque values obtained for Example 7 and KHI5 in 200 mL DRILLSOL® PLUS: brine (75:25) and sweet mixed gases (Table IV) at 1900 psi (˜15° C. subcooling); 20-4° C., 150 rpm). The torque values were obtained for a control (1510), 1% KHI5 (1520), 3% KHI5 (1530) and 3% Example 7 (1540). As depicted in FIG. 15, 3% Example 7 (applied neat) prevented hydrate agglomeration with low torque values (<4 N·cm), compared to the control at maximum 20 N·cm and 3% KHI5 at maximum 15 N·cm.

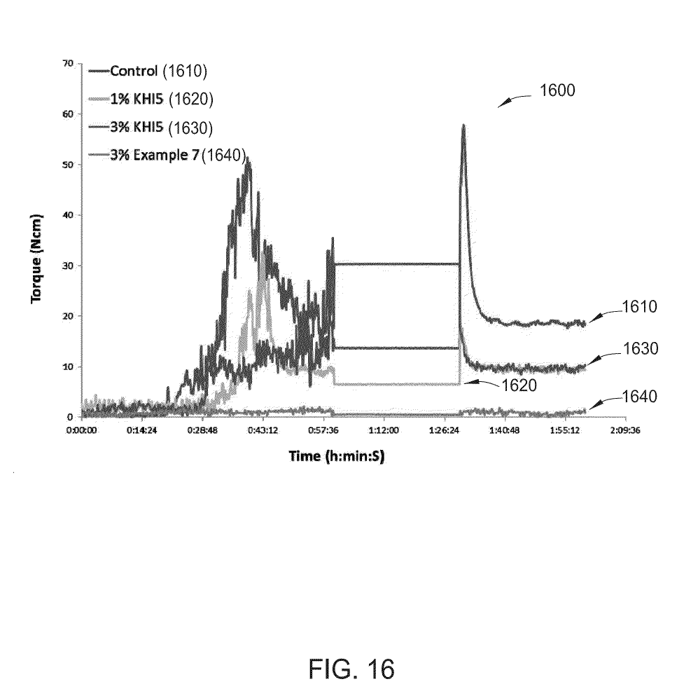

FIG. 16 depicts a plot 1600 illustrating the torque values obtained for Example 7 and KHI5 in 25% water cut and 1% H₂S mixed gases (Table IVA) (DRILLSOL® PLUS: tap water (75:25) (200 mL); 1900 psi, 20-4° C., 150 rpm, ˜15° C. subcooling). The torque values were obtained for a control (1610), 1% KHI5 (1620), 3% KHI5 (1630) and 3% Example 7 (1640). Very low torques (<3 N·cm) were obtained for 3% Example 7 compared to KHI5 (maximum 35 N·cm) and (control maximum 60 N·cm).

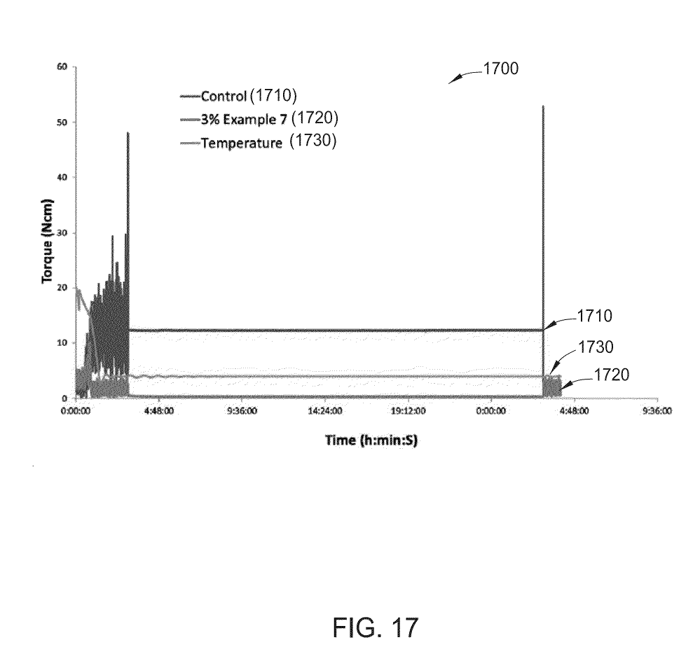

FIG. 17 depicts a plot 1700 illustrating the torque values (at 800 rpm) obtained for Example 7 in 75% water cut and 1% H₂S mixed gases (DRILLSOL® PLUS-tap water (25:75) (200 mL); 1900 psi, 20-4° C., ˜15° C. subcooling). The torque values were obtained for a control (1710) and 3% Example 7 (1720). Shut in occurs at the first point of maximum torque for 3 days, then stirred for a further 1 hour. Example 7 (3%/water phase, applied neat) remained effective with lower torque values (maximum 10 N·cm) compared to the control (51 N·cm).

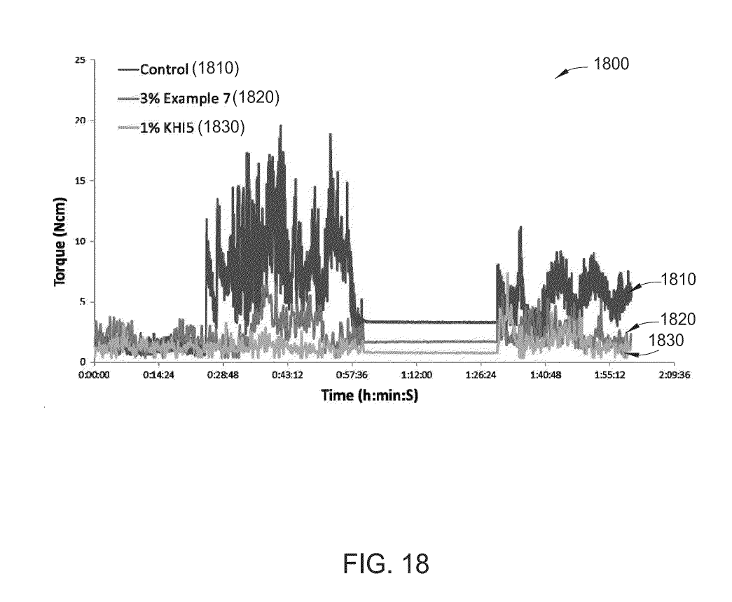

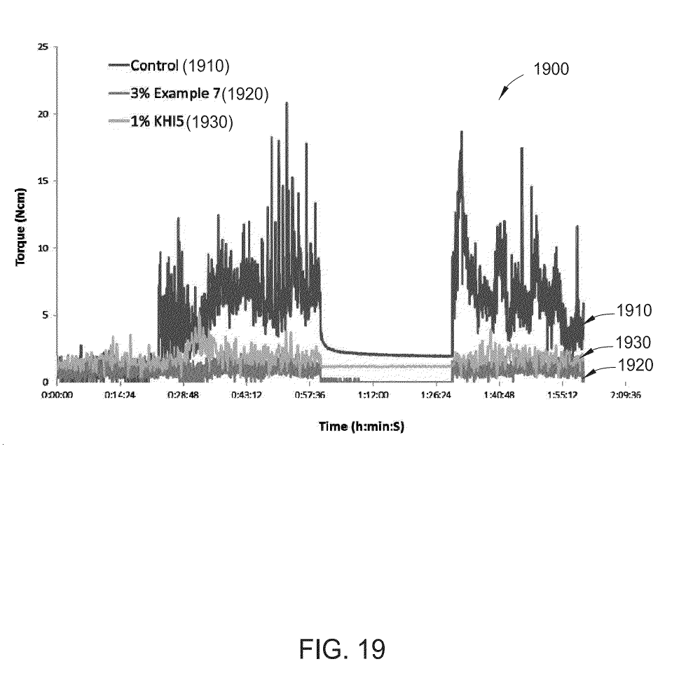

FIG. 18 depicts a plot 1800 illustrating the torque values obtained for 3% Example 7 in 100% water cut and sweet mixed gases at 1100 psi (Tap water only=200 mL; 20-4° C., 150 rpm). The torque values were obtained for a control (1810), 3% Example 7 (1820) and 1% KHI5 (1830). As depicted in FIG. 19, Example 7 (applied neat) performed in 100% water cut at 3%/water phase (torque=8 N·cm) compared to the control at (20 N·cm).

FIG. 19 depicts a plot 1900 illustrating the torque values obtained for Example 7 in 100% water cut and 1% H₂S gas mixture at 1100 psi (Tap water only=200 mL; 20-4° C., 150 rpm)). The torque values were obtained for a control (1910), 3% Example 7 (1920) and 1% KHI5 (1930). As depicted in FIG. 19, Example 7 (applied neat) performed in 100% water cut at 3%/water phase (torque=2.5 N·cm) compared to the control at (20.8 N·cm). Some results of sour system testing are shown in Table VI.

TABLE VI

| Examples in 100% water and | |
|---|---|
| gases to form sour (1% H₂S) type | Maximum Torque |
| II hydrates at 1100 psi | (N · cm) |
| Pre-test stirring of fluids | 1.9 |
| (no hydrates) | |
| Control | 20.8 |
| 3% of Example 7 | 2.5 |
| 2% of Example 8 | 11.4 |
| 3% of Example 10 | 10.0 |
| 3% of Example 12 | 12.8 |
| 3% of Example 18 | 2.6 |
| 3% of Example 19 | 2.4 |
| 3% of Example 20 | 2.5 |

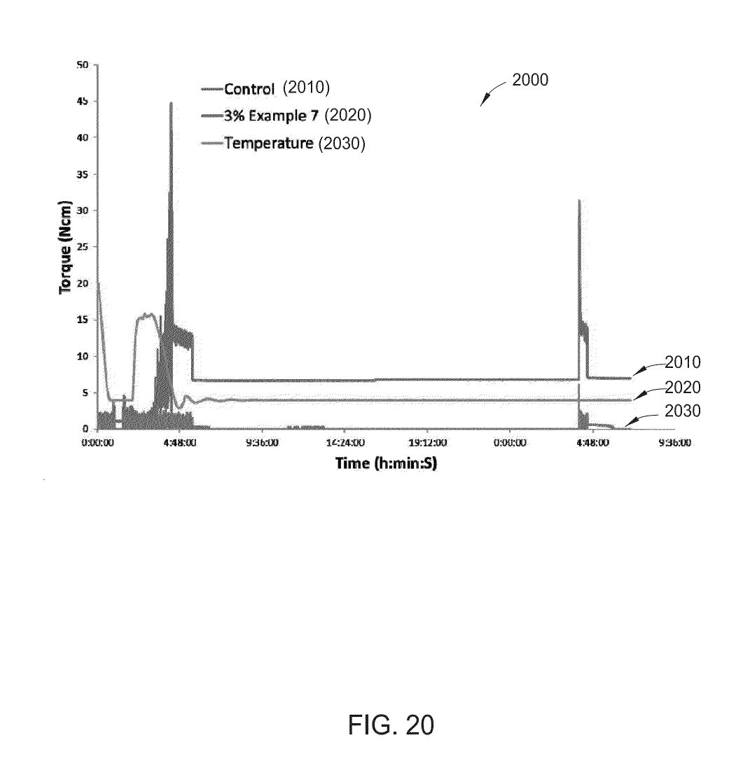

FIG. 20 depicts a plot 2000 illustrating the torque obtained from analyzing memory effect. There are speculations in the literature that memory effect may be a factor that affects how well inhibitors work. This memory effect can be seen where a system cools, heats and cools, resulting in accelerated hydrate crystal formation. The heating typically done in experiment is 1-3° C. above the hydrate dissociation point. Tests were carried out with Example 7 at 3%/water phase in 100% water cut (1100 psi, mixed gases see Table III). The tests were then repeated after script end, without take down, using a new 24 hour shut in script. The latter consisted of decreasing the temperature to 4° C., heating to 15° C. then decreasing temperature to 4° C. The torque values obtained are shown in FIG. 20. The control produced a maximum torque of 44.5 N·cm compared to 3% Example 7 with 6 N·cm dropping to ˜1 N·cm.

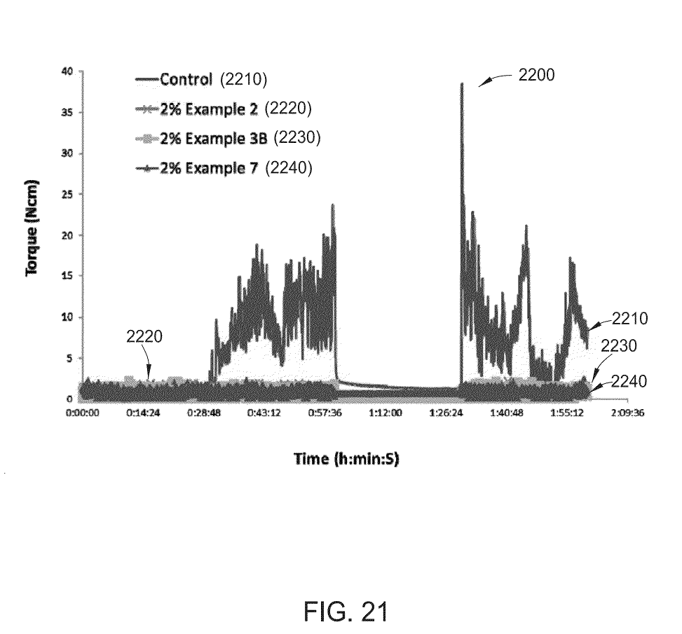

FIG. 21 depicts a plot 2200 illustrating the torque values obtained for various anti-agglomerants in 100% water cut, 4% H₂S, 3% carbon dioxide and 93% methane (Tap water only=200 mL; 1915 psi, 20-4° C., ˜17 C subcooling). The torque values were obtained for 2% Example 2 (2220), 2% Example 3B (2230) and 2% Example 7 (2240). As shown in FIG. 21, in 100% water cut, 2% (per water phase) of AAs Example 2, Example 3B and Example 7 maintained low torque values (<3 N·cm compared to maximum 40 N·cm for the control).

DRILLSOL® PLUS was used to provide the hydrocarbon layer for AAs testing. This allowed for sufficient hydrates to be formed with high torque. FRAC CLEAR™ and ENVIRODRILL® were also used but hydrates formed in the presence of these media resulted in low torque.

In a type 1 hydrate system Example 2, Example 3B, Example 7 (at 2% per water phase) were shown to be the best anti-agglomerants among the chemicals tested in condensate: tap water (75:25). They remained effective with water cut at 100% and H₂S at 4%. In a type II hydrate system, Example 7 was effective at concentrations below 0.25% in condensate: tap water (75:25) and 3% in 100% water cut. The activities of these anti-agglomerants are not diminished by the presence of corrosion inhibitors and may contribute to decreased corrosion rates.

While the foregoing is directed to implementations of the present invention, other and further implementations of the invention may be devised without departing from the basic scope thereof, and the scope thereof is determined by the claims that follow.

1. A composition comprising:
diethyl sulfate quaternaries of the reaction product of tall oil fatty acid; and
a mixture of aminoethylethanolamine, N-(2-aminoethyl)piperazine and triethylenetetramine.

2. The composition of claim 1, wherein the mixture further comprises 5-ethyl-1,4,7-triazabicylo(4.3.0) non-6-ene, 5-ethyl-1,4,7-triazabicyclo(4.3.0)non-4,6-diene, and N-(2-hydroxyethyl)piperazine.

3. A method of inhibiting the formation of hydrate agglomerates in a fluid comprising water, gas, and optionally liquid hydrocarbon, the method comprising:
adding to the fluid an effective anti-agglomerant amount of an anti-agglomerant composition comprising the diethyl sulfate quaternaries of the reaction product of tall oil fatty acid and a mixture of aminoethylethanolamine, N-(2-aminoethyl)piperazine and triethylenetetramine.

4. The method of claim 3, wherein the mixture further comprises 5-ethyl-1,4,7-triazabicylo(4.3.0) non-6-ene, 5-ethyl-1,4,7-triazabicyclo(4.3.0)non-4,6-diene, and optionally N-(2-hydroxyethyl)piperazine.

5. The method of claim 3, wherein the mixture further comprises N-(2-hydroxyethyl)piperazine.

6. The method of claim 3, wherein the gas comprises hydrogen sulfide.

7. The method of claim 3, wherein the fluid has a water cut from 0.1% to 100% v/v.

8. The method of claim 3, wherein the fluid is contained in an oil or gas pipeline or refinery.

9. The method of claim 3, wherein the fluid has a salinity of 1% to 35% w/w percent total dissolved solids (TDS).

10. The method of claim 3, wherein adding to the fluid the effective anti-agglomerant amount of the anti-agglomerant composition comprises adding an effective corrosion inhibition amount of the anti-agglomerant composition.

11. The method of claim 3, wherein the anti-agglomerant composition further comprises at least one component selected from: asphaltene inhibitors, paraffin inhibitors, corrosion inhibitors, scale inhibitors, emulsifiers, water clarifiers, dispersants, emulsion breakers, and combinations thereof.

12. The method of claim 3, wherein the anti-agglomerant composition further comprises at least one solvent selected from the group consisting of: isopropanol, methanol, ethanol, 2-ethylhexanol, heavy aromatic naphtha, toluene, ethylene glycol, ethylene glycol monobutyl ether (EGMBE), diethylene glycol monoethyl ether, xylene, and combinations thereof.

13. A method of inhibiting the formation of hydrate agglomerates in a fluid comprising water, gas, and optionally liquid hydrocarbon, the method comprising:
adding to the fluid an effective anti-agglomerant amount of an anti-agglomerate composition comprising the diethyl sulfate quaternaries of the reaction product of tall oil fatty acid and N-(2-aminoethyl)ethanolamine (AEEA).

14. The method of claim 13, wherein the anti-agglomerant composition further comprises an effective hydrate performance inhibitor enhancing amount of at least one of:
(a) diethyl sulfate quaternaries of the reaction product of tall oil fatty acid and triethylenetetramine; and
(b) diethyl sulfate quaternaries of the reaction product of tall oil fatty acid and diethylenetriamine.

15. The method of claim 13, wherein the gas comprises hydrogen sulfide.

16. The method of claim 13, wherein the fluid has a water cut from 0.1% to 100% v/v.

17. The method of claim 13, wherein the fluid is contained in an oil or gas pipeline or refinery.

18. The method of claim 13, wherein the fluid has a salinity of 1% to 35% w/w percent total dissolved solids (TDS).

19. The method of claim 13, wherein adding to the fluid an effective anti-agglomerant amount of the anti-agglomerate composition comprises adding an effective corrosion inhibition amount of the anti-agglomerate composition.

20. The method of claim 13, wherein the anti-agglomerant composition further comprises at least one component selected from: asphaltene inhibitors, paraffin inhibitors, corrosion inhibitors, scale inhibitors, emulsifiers, water clarifiers, dispersants, emulsion breakers, and combinations thereof.
